(19) United States
(12) Patent Application Publication
(10) Pub. No.: US 2006/0038750 A1
(43) Pub. Date: Feb. 23, 2006

(54) Driving apparatus of plasma display panel and plasma display

(75) Inventors: Manabu Inoue, New York, NY (US); Satoshi Ikeda, Osaka (JP); Yasuhiro Arai, Osaka (JP); Hideki Nakata, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/140,744

(22) Filed: Jun. 1, 2005

(30) Foreign Application Priority Data
Jun. 2, 2004 (JP) 2004-164593

(51) Int. Cl. G09G 3/28

(52) U.S. Cl. 345/60

(57) ABSTRACT

A driving apparatus of a plasma display panel includes a sustain generator section that sustains sustain electrodes at a specific potential (ground potential) and applies alternately a first positive pulse voltage and a first negative pulse voltage to scan electrodes, as a sustain pulse voltage, during a sustain period, and an address voltage generator that applies a voltage changing temporally to address electrodes. The address voltage generator applies a second pulse voltage with a predetermined polarity to the address electrode in synchronization with a pulse with the same polarity as the second pulse voltage out of sustain pulse voltages during the sustain period.

### BACKGROUND OF THE INVENTION

1. Field of the Invention

The present invention relates to a driving apparatus of a plasma display panel (PDP) and a plasma display.

2. Related Art

Plasma display is a display device making use of light emitting phenomenon by gas discharge. The display portion of the plasma display, that is, the plasma display panel (PDP) is more advantageous than other display devices in the aspects of large screen, thin panel, and wide viewing angle. PDP is roughly classified into DC type operating using direct-current pulses, and AC type operating using alternating-current pulses. The AC type PDP is particularly high in luminance, and simple in structure. Therefore, the AC type PDP is suited to mass production and finer pixel size, and is used in a wide range.

An AC type PDP has, for example, a three-electrode surface discharge structure (see, for example, patent document 1). In this structure, an address electrode is disposed on a back substrate of PDP in longitudinal direction of the panel, and a sustain electrode and a scan electrode (also called X electrode and Y electrode respectively) are disposed on a front substrate of PDP alternately in lateral direction of panel. The address electrode and scan electrode can generally change the potential individually one by one.

At the intersection of a pair of mutually adjacent sustain electrode and scan electrode and the address electrode, a discharge cell is disposed. On the surface of the discharge cell, a layer made of dielectric (dielectric layer), a layer for protecting electrode and dielectric layer (protective layer), and a layer including phosphor (phosphor layer) are provided. Gas is filled inside of the discharge cell. While discharge is occurring in the discharge cell by application of pulse voltage to the sustain electrode, scan electrode and address electrode, gas molecules are ionized to emit ultraviolet rays. The ultraviolet rays excite the phosphor on the discharge cell surface to generate fluorescence. As a result, the discharge cell emits light.

A PDP driving apparatus generally controls potentials of the sustain electrode, scan electrode and address electrode of PDP according to ADS (address display-period separation) method. The ADS method is a kind of sub-field method. In sub-field method, one field of image is divided into plural sub-fields. Each sub-field includes a reset period, an address period, and a sustain period. In particular, in the ADS method, these three periods are set commonly in all discharge cells of PDP (see, for example, patent document 1).

In the reset period, a reset pulse voltage is applied between the sustain electrode and scan electrode. As a result, the wall charge is made uniform in all discharge cells.

In the address period, a scan pulse voltage is sequentially applied to the scan electrode, and an address pulse voltage is applied to some of the address electrodes. Herein, the address electrodes to which the address pulse voltage is applied are selected on the basis of a video signal entered from outside. When a scan pulse voltage is applied to one scan electrode and an address pulse voltage is applied to one address electrode, discharge occurs in the discharge cell positioned at the intersection of the scan electrode and address electrode. By this discharge, a wall charge is accumulated on the discharge cell surface.

In the sustain period, a sustain pulse voltage is applied to all pairs of sustain electrode and scan electrode simultaneously and periodically. Herein, the sustain pulse voltage is lower than a firing voltage. However, in the discharge cell in which the wall charge is accumulated in the address period, the voltage by wall charge, that is, the wall voltage is added to the sustain pulse voltage. Therefore, the voltage between the sustain electrode and scan electrode exceeds the firing voltage. As a result, discharge by gas continues, and luminance occurs.

Duration of sustain period differs in each sub-field, and the light emitting time per field of discharge cell, that is, the luminance of discharge cell is adjusted by selection of sub-fields to be emitted.

The PDP driving apparatus generally includes three drivers including a scan electrode driver, a sustain electrode driver, and an address electrode driver. These three drivers independently or in cooperation generate a reset pulse voltage, a scan pulse voltage, an address pulse voltage, and a sustain pulse voltage.

Pulse voltages by these three drivers are generated in various modes.

For example, the following is known as a mode of generation of sustain pulse voltage by a conventional PDP driving apparatus (for example, patent document 1).

FIG. 15 is an equivalent circuit diagram of PDP driving apparatus showing a scan electrode driver 110, a sustain electrode driver 120, an address electrode driver 130, and a PDP 200 in sustain period. In FIG. 15, the equivalent circuit of the PDP 200 is expressed only by floating capacities CXY, CXA, and CYA among a sustain electrode X, a scan electrode Y and an address electrode A (hereinafter called panel capacity of PDP 200). A path of a current flowing in the PDP 200 when discharging in the discharge cell, that is, a discharge current is omitted.

FIG. 16 is a waveform diagram showing potential changes of the scan electrode Y, the sustain electrode X, and the address electrode A during sustain period.

During sustain period, the scan electrode driver 110 sustains the scan electrode Y at ground potential (nearly 0), and the address electrode driver 130 sustains the address electrode A at ground potential (see FIG. 16).

The sustain electrode driver 120 includes a high side switch Q1 and a low side switch Q2. The high side switch Q1 and the low side switch Q2 are connected in series between a positive potential terminal 1P and a negative potential terminal 1N of a power source 100. Further, a junction point J1 of this series connection is connected to the sustain electrode X of PDP 200. Herein, the positive potential terminal 1P is sustained at a specific positive potential +Vs, and the negative potential terminal 1N is sustained at a specific negative potential −Vs.

During sustain period, the high side switch Q1 and the low side switch Q2 are turned on and off alternately. As a result, the positive pulse voltage (pulse height: +Vs) and the negative pulse voltage (pulse height: −Vs) are applied to the sustain electrode X alternately as sustain pulse voltage (see FIG. 16).
*** Patent document 1: JP, 08-320667, A.

Generally, the PDP driving apparatus is provided with a circuit for driving the sustain electrode and others during sustain period, and a circuit for driving the sustain electrode and others during address period and reset period. During sustain period, a large current composed of a discharge current and charge/discharge currents of the panel capacity flows in the PDP. Accordingly, the circuit for driving the sustain electrode and others during sustain period is made large, preventing the entire driving apparatus from being downsized.

### SUMMARY OF THE INVENTION

The present invention is devised to solve the above problems, and it is hence an object thereof to present a PDP driving apparatus and plasma display capable of realizing reduction of size.

The PDP driving apparatus of the invention is implemented in a plasma display. The plasma display has the following plasma display panel (PDP). The PDP includes:
discharge cells for emitting light by discharge of gas packed inside, and
sustain electrodes, scan electrodes, and address electrodes for applying a predetermined voltage to the discharge cells.

The PDP driving apparatus of the invention includes a sustain pulse generating section and an address voltage generator.

The sustain pulse generating section sustains one of the sustain electrode and scan electrode at predetermined potential (ground potential) during a sustain period, and applies alternately a first positive pulse voltage and a first negative pulse voltage to the other, as sustain pulse voltage. The address voltage generator applies a voltage changing temporally to the address electrode. Meanwhile, the address voltage generator may also apply a second pulse voltage of a specific polarity to the address electrode, in synchronization with the pulse with the same polarity as the second pulse voltage out of the sustain pulse voltage.

In the PDP driving apparatus of the invention, during the sustain period, either the sustain electrode or the scan electrode is sustained at the ground potential. That is, either the sustain electrode driver or the scan electrode driver include no sustain pulse generating section. Hence, the entire area of the driving apparatus can be curtailed, and the flexibility of circuit design is enhanced, so that the PDP driving apparatus of the invention may be easily reduced in size.

The PDP driving apparatus of the invention further applies a second pulse voltage to the address electrode when the first positive pulse voltage or first negative pulse voltage is applied to either the sustain electrode or the scan electrode. Preferably, even if the amplitude of the second pulse voltage is large, it is equal to that of the sustain pulse voltage which has a pulse of the same polarity as the second pulse voltage. At this time, the discharge through the address electrode is suppressed as follows.

Upon start of the sustain period, wall charge is accumulated on the address electrode. The wall charge has a specific polarity.

For example, suppose the polarity of the wall charge is positive.

In this case, during the application period of the first negative pulse voltage, the second pulse voltage of negative polarity is applied. At this time, the voltage between an electrode to which the first negative pulse voltage is applied and the address electrode is lower than the voltage between the sustain electrode and the scan electrode. Therefore, on the address electrode side, erasure of positive wall charge is suppressed. In other words, the discharge current does not flow in the address electrode substantially. At the address electrode side, further, impact by electrons is reduced.

On the other hand, during the application period of the first positive pulse voltage, a positive wall charge accumulated at the address electrode is sustained constant. That is, the discharge current does not flow in the address electrode.

Contrary to this assumption, suppose the polarity of wall charge accumulated at the address electrode is negative, then second pulse voltage of positive polarity is applied during application period of first positive pulse voltage.

As a result, throughout the entire sustain period, substantially, a specific wall charge is sustained at the address electrode side. That is, the discharge current does not flow in the address electrode substantially. Since the electron/ion impact is further reduced on the address electrode side, deterioration of phosphor is effectively prevented.

Thus, the PDP driving apparatus of the invention is kept low in power consumption of the PDP, and kept long in the life of the PDP.

The address voltage generator may also change the address electrode potential from the ground potential to negative predetermined potential while the sustain pulse voltage changes from maximum to minimum, and change the address electrode potential from the negative predetermined potential to the ground potential while the sustain pulse voltage changes from minimum to maximum, during the sustain period.

Further, the address voltage generator may control the address electrode potential of the PDP at least in two different potentials, lower the address electrode potential during application of the first positive pulse voltage, and raise the address electrode potential during application of the first negative pulse voltage, during the sustain period. Moreover, the address voltage generator may lower the address electrode potential while the sustain pulse voltage changes from maximum to minimum, and raise the address electrode potential while the sustain pulse voltage changes from minimum to maximum, during the sustain period.

Preferably, the lower voltage applied to the address electrode by the address voltage generator is the ground potential. Thus, during the sustain period, after finishing one discharge, by raising or lowering the address electrode potential, the wall charge on the address electrode side can be adjusted. As a result, the discharge current does not flow substantially in the address electrode. At the address electrode, further, since electron/ion impact is reduced, deterioration of phosphor is prevented effectively. Thus, the PDP driving apparatus of the invention is kept low in power consumption of PDP, and kept long in the life of PDP.

The PDP driving apparatus of the invention preferably includes a reset pulse generating section for sustaining the sustain electrode at the ground potential during a reset period and applying a reset pulse to the scan electrode, and a scan pulse generating section for sustaining the sustain electrode at the ground potential during an address period and applying a scan pulse voltage to the scan electrode. At this time, the sustain pulse generating section sustains the sustain electrode at the ground potential during the sustain period.

Accordingly, substantially, the sustain electrode is always sustained at the ground potential. Therefore, the junction part to the sustain electrode of the PDP driving apparatus, that is, the sustain electrode driver does not have to include a pulse generating section. Preferably, generators of pulse voltages and power sources are concentrated in layout on the scan electrode of the PDP side. That is, the noise source and heat source of the PDP driving apparatus are gathered on the scan electrode of the PDP side. Consequently, measures against noise and heat can be easily taken. For example, if high frequency circuits, such as tuners, relatively less resistant to noise are disposed on the sustain electrode of the PDP side, adverse effects by noise of the PDP driving apparatus can be effectively avoided. Furthermore, the cooling range by fans or other cooling device may be limited to the scan electrode of the PDP side, so that the cooling efficiency may be enhanced effectively. Therefore, from the viewpoint of saving energy, too, an ideal PDP driving apparatus or plasma display can be presented. Besides, the number of parts is curtailed, and an inexpensive PDP driving apparatus or plasma display can be presented.

In the PDP driving apparatus of the invention, as mentioned above, during the sustain period, either the sustain electrode or the scan electrode is sustained at the ground potential. That is, either the sustain electrode driver or the scan electrode driver does not include the sustain pulse generating section, so that the entire area of the PDP driving apparatus is curtailed, and the flexibility of circuit design is enhanced.

Thus, the PDP driving apparatus of the invention can be easily reduced in size.

### BRIEF DESCRIPTION OF THE DRAWINGS

FIG. 1 is a block diagram of a plasma display in embodiment 1 of the invention.

FIG. 2 is a block diagram of an equivalent circuit of a PDP 10 and a PDP driving apparatus 30 in embodiment 1 of the invention.

FIG. 3A is an equivalent circuit diagram of a first sustain pulse generating section 2A in embodiment 1 of the invention.

FIG. 3B is an equivalent circuit diagram of the other preferred example of a first sustain pulse generating section 2A in embodiment 1 of the invention.

FIG. 4 is an equivalent circuit diagram of a second sustain pulse generating section 4B in embodiment 1 of the invention.

FIG. 5A is a waveform diagram showing potential changes in a scan electrode Y, a sustain electrode X and an address electrode A of PDP 10 in a sustain period, in embodiment 1 of the invention. It also shows ON periods of switch elements Q1, Q2, Q3A, Q4A, Q3B, Q4B and Q7 included in the first sustain pulse generating section 2A, and ON periods of switch elements Q5, Q6, Q3C and Q4C included in the second sustain pulse generating section 4B.

FIG. 5B is a waveform diagram showing potential changes in the scan electrode Y, the sustain electrode X and the address electrode A of the PDP 10 in an other preferred sustain period, in embodiment 1 of the invention. It also shows ON periods of switch elements Q1, Q2, Q3D, Q4D and Q7 included in the first sustain pulse generating section 2A, and ON periods of switch elements Q5, Q6, Q3C and Q4C included in the second sustain pulse generating section 4B.

FIG. 6 is a block diagram of an equivalent circuit of the PDP 10 and the PDP driving apparatus 30 in embodiment 2 of the invention,

FIG. 7 is an equivalent circuit diagram of a scan electrode driver 2 in embodiment 2 of the invention.

FIG. 8 is an equivalent circuit diagram of an address electrode driver 4 in embodiment 2 of the invention.

FIG. 9 is a waveform diagram showing potential changes in the scan electrode Y, the sustain electrode X and the address electrode A of the PDP 10 in a reset period, an address period, and a sustain period, respectively, in embodiment 2 of the invention. It also shows ON periods of switch elements Q1, Q2, QS1, QS2, Q7, QB, QR1, QR2, QY1 and QY2 included in the scan electrode driver 2, and ON periods of switch elements Q5, Q6, QS3, Q8, QA1 and QA2 included in the address electrode driver 4.

FIG. 10 is a block diagram of an equivalent circuit of the PDP 10 and the PDP driving apparatus 30 in embodiment 3 of the invention.

FIG. 11A is a waveform diagram showing potential changes in the scan electrode Y, the sustain electrode X and the address electrode A of the PDP 10 in a sustain period, in embodiment 3 of the invention. It also shows ON periods of switch elements Q1, Q2, Q3A, Q4A, Q3B, Q4B and Q7 included in the first sustain pulse generating section 2A, and ON periods of switch elements Q5, Q6, Q3C and Q4C included in the second sustain pulse generating section 4B.

FIG. 11B is a waveform diagram showing potential changes in the scan electrode Y, the sustain electrode X and the address electrode A of the PDP 10 in other preferred sustain period, in embodiment 3 of the invention. It also shows ON periods of switch elements Q1, Q2, Q3D, Q4D and Q7 included in the first sustain pulse generating section 2A, and ON periods of switch elements Q5, Q6, Q3C and Q4C included in the second sustain pulse generating section 4B.

FIG. 12 is a block diagram of equivalent circuit of PDP 10 and PDP driving apparatus 30 in embodiment 4 of the invention,

FIG. 13 is an equivalent circuit diagram of address electrode driver 4 in embodiment 4 of the invention,

FIG. 14 is a waveform diagram showing potential changes in the scan electrode Y, the sustain electrode X and the address electrode A of the PDP 10 in a reset period, an address period, and a sustain period in embodiment 4 of the invention. It also shows ON periods of switch elements Q1, Q2, QS1, QS2, Q7, QB, QR1, QR2, QY1 and QY2 included in the scan electrode driver 2, and ON periods of switch elements Q5, Q6, QS4, Q9, QA1, QA2, Q3C and Q4C included in the address electrode driver 4.

FIG. 15 is an equivalent circuit diagram of a scan electrode driver 110, a sustain electrode driver 120, an address electrode driver 130, and a PDP 200, in a sustain period, in a PDP driving apparatus in prior art.

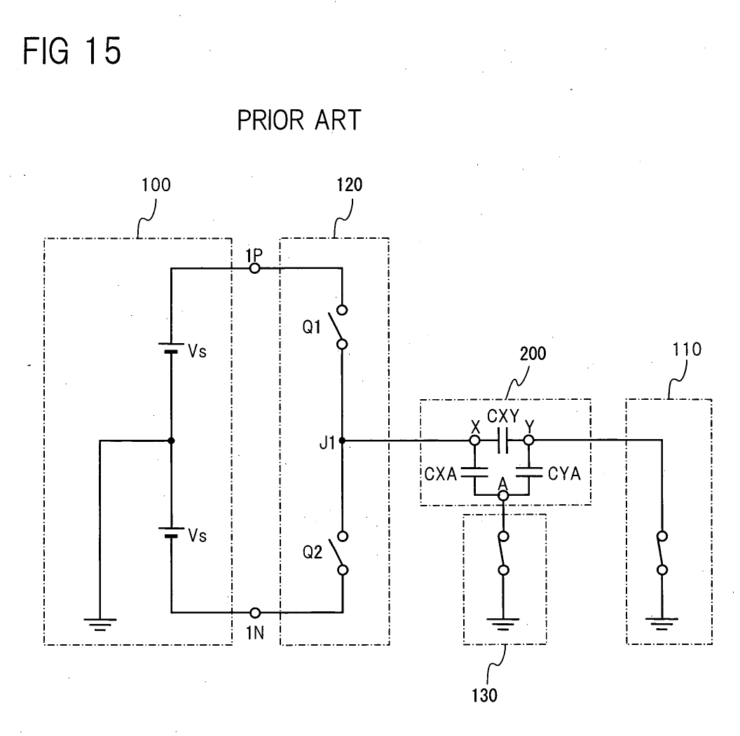

FIG. 16 is a waveform diagram showing potential changes in a scan electrode Y, a sustain electrode X and an address electrode A in a sustain period, in the PDP driving apparatus in prior art.

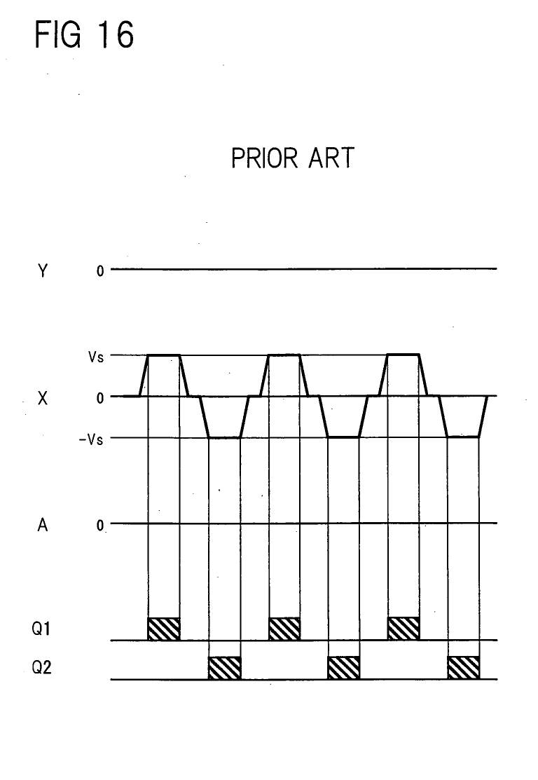

### DETAILED DESCRIPTION OF THE PREFERRED EMBODIMENTS

Referring now to the drawings, preferred embodiments of the invention are described specifically below.

### Embodiment 1

This embodiment explains structure and operation of a PDP driving apparatus for driving while fixing a potential of a sustain electrode (or scan electrode) at a specific value during a sustain period. By fixing the potential of the sustain electrode (or scan electrode) at a specific value during a sustain period, a circuit for driving the sustain electrode (or scan electrode) during the sustain period can be eliminated, and the driving apparatus can be reduced in size and saved in power consumption.

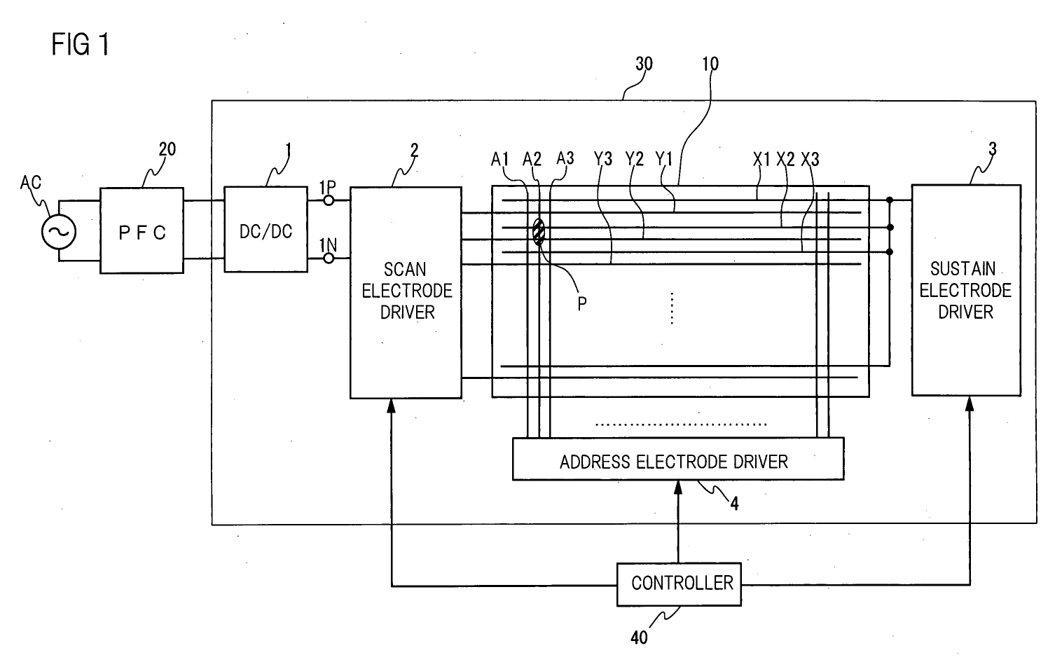

FIG. 1 is a block diagram of a plasma display of embodiment 1 according to the invention. The plasma display includes a PDP (plasma display panel) 10, a power factor correction converter (PFC) 20, a PDP driving apparatus 30, and a controller 40. The PDP 10 is, for example, AC type, having three-electrode surface discharge type structure. On a back substrate of the PDP 10, address electrodes A1, A2, A3, . . . are disposed in the longitudinal direction of the panel. On a front substrate of the PDP 10, sustain electrodes X1, X2, X3, . . . and scan electrodes Y1, Y2, Y3, . . . are disposed alternately and in the lateral direction of the panel. The sustain electrodes X1, X2, X3, . . . are mutually connected, and substantially equal in potential. The address electrodes A1, A2, A3, . . . and scan electrodes Y1, Y2, Y3, . . . are capable of changing the potential individually one by one. A discharge cell is disposed at intersection of a pair of mutually adjacent sustain electrode and scan electrode (for example, a pair of sustain electrode X2 and scan electrode Y2), and an address electrode (for example, address electrode A2) (see, for example, shaded area P in FIG. 1). On the surface of the discharge cell, a layer made of dielectric (dielectric layer), a layer for protecting the electrode and the dielectric layer (protective layer), and a layer including phosphor (phosphor layer) are provided. Inside of the discharge cell is packed with gas. Discharge occurs in the discharge cell when a predetermined pulse voltage is applied to the sustain electrode, the scan electrode and the address electrode. At this time, gas molecules in the discharge cell are ionized to emit ultraviolet rays. The ultraviolet rays excite the phosphor on the discharge cell surface to generate fluorescence. As a result, the discharge cell emits light.

The PFC 20 is connected to an external commercial alternating-current power source AC. The PFC 20 receives an alternating-current power from the commercial alternating-current power source AC, and converts this alternating-current power into direct-current power. Further with switching operation, the PFC 20 maintains the power factor of the power from the commercial alternating-current power source AC substantially at 1. Instead of the PFC 20, the plasma display may also be provided with an AC-DC converter which does not correct the power factor. Besides, it may also have only a full wave rectifier or a voltage doubler rectifier including a diode bridge and a capacitor.

The PDP driving apparatus 30 includes a DC-DC converter 1, a scan electrode driver 2, a sustain electrode driver 3, and an address electrode driver 4. The DC-DC converter 1 converts the output voltage of the PFC 20 into a positive direct-current voltage +Vs and a negative direct-current voltage −Vs, and maintains two output terminals 1P and 1N at positive potential +Vs and negative potential −Vs, respectively. These two positive and negative direct-current voltages are preferably equal in magnitude Vs. These output terminals are hereinafter called positive potential terminal 1P and negative potential terminal 1N, respectively. The scan electrode driver 2, the sustain electrode driver 3, and the address electrode driver 4 individually include switch elements. A pulse voltage is generated by switching operation of these switch elements. An input terminal of the scan electrode driver 2 is connected to the positive potential terminal 1P and the negative potential terminal 1N of the DC-DC converter 1. An output terminal of the scan electrode driver 2 is connected to scan electrodes Y1, Y2, Y3, . . . of the PDP 10, individually. The scan electrode driver 2 controls potentials of the scan electrodes Y1, Y2, Y3, . . . , respectively. The sustain electrode driver 3 is connected to sustain electrodes X1, X2, X3, . . . of the PDP 10. The sustain electrode driver 3 uniformly controls the potentials of sustain electrodes X1, X2, X3, . . . . The address electrode driver 4 is connected to address electrodes A1, A2, A3, . . . of the PDP 10, individually. The address electrode driver 4 controls the potentials of address electrodes A1, A2, A3, . . . , individually. The controller 40 controls the switching operation of the scan electrode driver 2, the sustain electrode driver 3, and the address electrode driver 4. The switching control is done according to ADS (address display-period separation) method. The ADS method is one kind of sub-field methods. In the sub-field method, one field of image is divided into plural sub-fields. Each sub-field includes a reset period, an address period, and a sustain period. In particular, in the ADS method, these three periods are provided commonly to all discharge cells of the PDP 20.

In the reset period, a reset pulse voltage is applied between sustain electrodes X1, X2, X3, . . . and scan electrodes Y1, Y2, Y3, . . . of the PDP 10. As a result, wall charge is made uniform in all discharge cells.

In the address period, a scan pulse voltage is sequentially applied to scan electrodes Y1, Y2, Y3, . . . . In synchronization with a scan pulse voltage, an address pulse voltage is applied to some of address electrodes A1, A2, A3, . . . . Herein, address electrodes to which a address pulse voltage is applied is selected on the basis of a video signal entered from outside. When a scan pulse voltage is applied to one electrode Y2 of the scan electrodes and an address pulse voltage is applied to one electrode A2 of the address electrodes, discharge occurs in the discharge cell positioned at intersection P of the scan electrode Y2 and the address electrode A2. This discharge allows wall charge to be accumulated on the surface of the discharge cell P.

During the sustain period, the sustain pulse voltage is applied between sustain electrodes X1, X2, X3, . . . and scan electrodes Y1, Y2, Y3, . . . , simultaneously and periodically. Herein, the sustain pulse voltage is lower than a firing voltage. However, in the discharge cell P where the wall charge is accumulated during the address period, since the wall voltage is added to the sustain pulse voltage, the voltage between the sustain electrode and the scan electrode exceeds the firing voltage. Therefore, discharge by gas continues, causing light emission. Since duration of sustain period varies in each sub-field, the light emitting time per field of the discharge cell, that is, the luminance of the discharge cell can be adjusted by selecting the sub-field for emitting light.

The controller 40 determines the address electrode to which the address pulse voltage is applied and the sub-field, on the basis of the video signal. As a result, an image corresponding to the video signal is reproduced in the PDP 10.

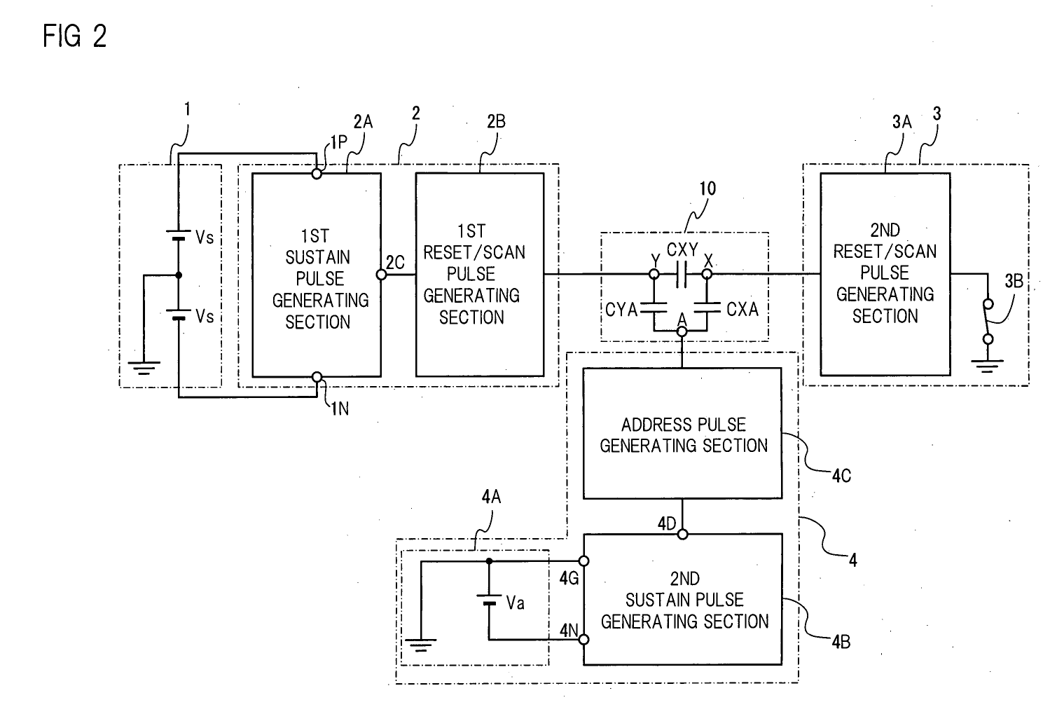

FIG. 2 is a block diagram of an equivalent circuit of the PDP 10 and the PDP driving apparatus 30 according to embodiment 1 of the invention. The equivalent circuit of the PDP 10 is expressed only by panel capacity, that is, floating capacities CXY, CXA, and CYA formed among the sustain electrode X, the scan electrode Y, and the address electrode A. A path of a current flowing through the PDP 10 when discharging in the discharge cell, that is, a discharge current, is omitted.

In the PDP driving apparatus 30 in embodiment 1 of the invention, unlike the conventional PDP driving apparatus, the sustain electrode driver 3 does not include a sustain pulse generating section, and instead the address electrode driver 4 includes a sustain pulse generating section. Hence, the PDP driving apparatus 30 has its feature in its operation during the sustain period. Structure and operation relating to action in the sustain period are mainly described below.

The DC-DC converter 1 is equivalent to series connection of two direct-current voltage sources. The voltage of the two direct-current voltage sources is commonly Vs. The junction point of the two direct-current voltage sources is grounded. As a result, the positive potential terminal 1P and negative potential terminal 1N are respectively sustained at positive potential +Vs and negative potential −Vs.

The scan electrode driver 2 includes a first sustain pulse generating section 2A and a first rest/scan pulse generating section 2B.

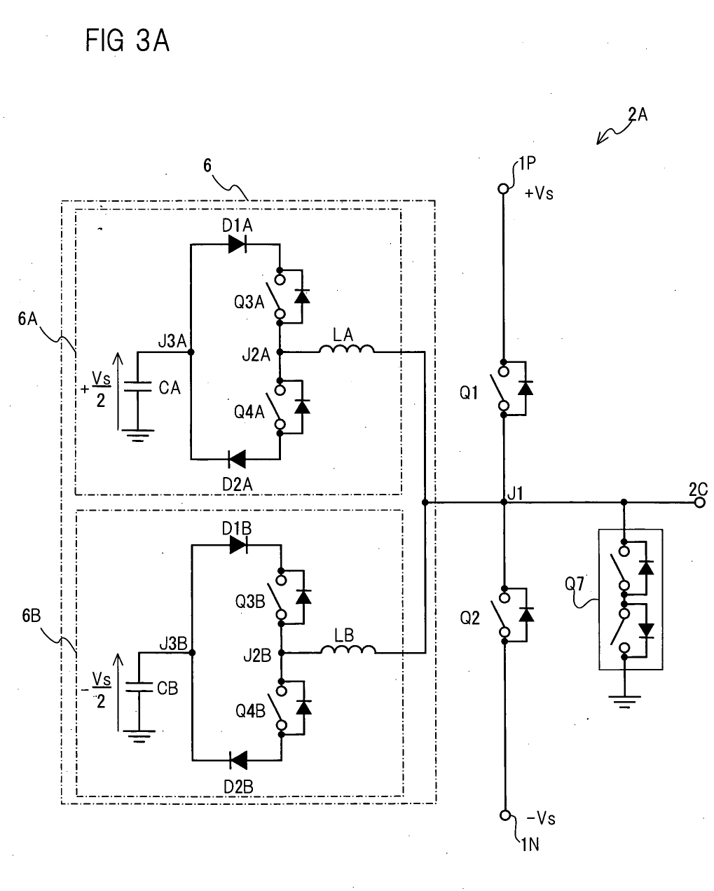

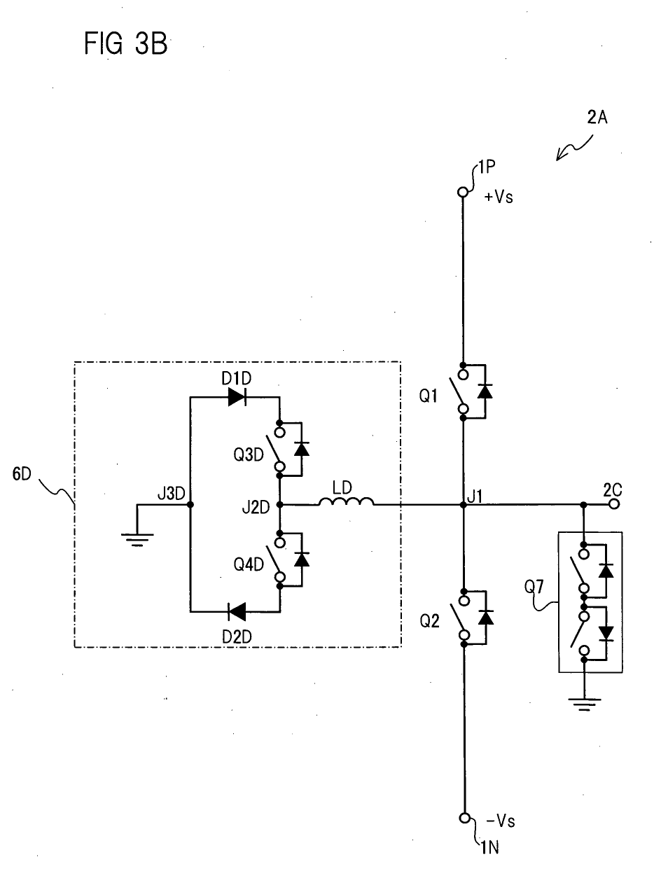

FIG. 3A is an equivalent circuit diagram of the first sustain pulse generating section 2A.

The first sustain pulse generating section 2A includes a first high side sustain switch element Q1, a first low side sustain switch element Q2, a bidirectional switch section Q7, and a power recovery section 6.

These two sustain switch elements Q1 and Q2 are, for example, MOSFETs. Alternatively, they may be IGBTs or bipolar transistors. In the following explanation, the switch elements are MOSFETs, and the switch element has terminals including gate, drain and source. In the case of IGBT, the corresponding terminals are base, collector, and emitter.

The drain of the first high side sustain switch element Q1 is connected to the first positive potential terminal 1P. The source of the first high side sustain switch element Q1 is connected to the drain of the first low side sustain switch element Q2. The source of the first low side sustain switch element Q2 is connected to the negative potential terminal 1N. A junction point J1 between the first high side sustain switch element Q1 and the first low side sustain switch element Q2 is connected to an output terminal 2C of the first sustain pulse generating section 2A.

The bidirectional switch section Q7 is a series connection of two switch elements, and the sources of switch elements are connected to each other. Or the drains of the switch elements are connected to each other. Thus, when the two switch elements are both turned off, no current flows in any direction. The on/off states of the two switch elements are always controlled equally. The bidirectional switch section Q7 is connected between the output terminal 2C and the ground terminal.

The power recovery section 6 includes two similar power recovery circuits 6A and 6B. The first power recovery circuit 6A includes a first recovery capacitor CA, a first high side diode D1A, a first low side diode D2A, a first high side recovery switch element Q3A, a first low side recovery switch element Q4A, and a first recovery inductor LA. The capacity of the first recovery capacitor CA is sufficiently larger than any one of panel capacitors CXY, CXA, and CYA of the PDP 10. A high potential terminal J3A of the first recovery capacitor CA is sustained at a potential substantially equal to a half (+Vs/2) of a potential (+Vs) of the positive potential terminal 1P.

A low potential terminal of the first recovery capacitor CA is grounded, and the high potential terminal J3A is connected to the anode of the first high side diode D1A. The cathode of the first high side diode D1A is connected to the drain of first high side recovery switch element Q3A. The source of the first high side recovery switch element Q3A is connected to the drain of the first low side recovery switch element Q4A. The source of the first low side recovery switch element Q4A is connected to the anode of the first low side diode D2A. The cathode of the first low side diode D2A is connected to the high potential terminal J3A of the first recovery capacitor CA.

A junction point J2A between the first high side recovery switch element Q3A and the first low side recovery switch element Q4A is connected to one end of the first recovery inductor LA. The other end of the first recovery inductor LA is connected to an output terminal 2C of the first sustain pulse generating section 2A.

The second power recovery circuit 6B includes a second recovery capacitor CB, a second high side diode D1B, a second low side diode D2B, a second high side recovery switch element Q3B, a second low side recovery switch element Q4B, and a second recovery inductor LB.

The characteristics and mutual connection of these elements are nearly same as in the first power recovery circuit 6A. However, the second recovery capacitor CB is reverse in polarity from the first recovery capacitor CA. That is, a high potential terminal of the second recovery capacitor CB is grounded, and a low potential terminal J3B is connected to the second high side diode D1B and the second low side diode D2B. Further, the low potential terminal J3B of the second recovery capacitor CB is sustained at a potential substantially equal to a half (−Vs/2) of a potential (−Vs) of the negative potential terminal 1N.

The first reset/scan pulse generating section 2B, during the sustain period, merely shorts the path between the output terminal 2C of the first sustain pulse generating section 2A and the scan electrode Y (see FIG. 2). On the other hand, during the reset and address periods, the first reset/scan pulse generating section 2B may operate in the same manner as the prior art, for example. Therefore, the detail of the first reset/scan pulse generating section 2B is omitted.

The sustain electrode driver 3 includes a second reset/scan pulse generating section 3A, and a grounding switch 3B (see FIG. 2).

The second reset/scan pulse generating section 3A, merely shorts the path between grounding switch 3B and sustain electrode X, during sustain period. On the other hand, during the reset and address periods, the second reset/scan pulse generating section 3A may operate, for example, in the same manner as the prior art. Hence, the detail of the second reset/scan pulse generating section 3A is omitted.

The grounding switch 3B is turned on to ground the sustain electrode X during the sustain period. Herein, the ground potential is 0 V, and preferably the chassis (not shown) of the PDP 10 is used as grounding conductor.

The address electrode driver 4 includes an address power source 4A, a second sustain pulse generating section 4B, and an address pulse generating section 4C (see FIG. 2).

The address power source 4A is a negative direct-current voltage source with a high potential terminal 4G grounded and a low potential terminal 4N sustained at a constant negative potential −Va. The output voltage Va of the address power source 4A is preferably not larger than an output voltage Vs of the DC-DC converter 1: Va≦Vs.

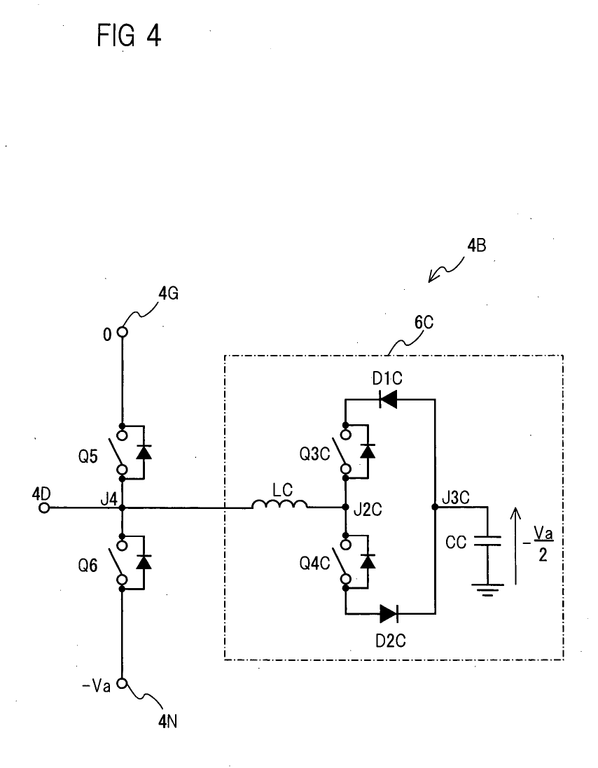

FIG. 4 is an equivalent circuit diagram of the second sustain pulse generating section 4B.

The second sustain pulse generating section 4B includes a second high side sustain switch element Q5, a second low side sustain switch element Q6, and a third power recovery circuit 6C. The drain of the second high side sustain switch element Q5 is connected to a high potential terminal 4G. The source of the second high side sustain switch element Q5 is connected to the drain of the second low side sustain switch element Q6. The source of the second low side sustain switch element Q6 is connected to a low potential terminal 4N.

A junction point J4 between the second high side sustain switch element Q5 and the second low side sustain switch element Q6 is connected to an output terminal 4D of the second sustain pulse generating section 4B.

The third power recovery circuit 6C includes a third recovery capacitor CC, a third high side diode D1C, a third low side diode D2C, a third high side recovery switch element Q3C, a third low side recovery switch element Q4C, and a third recovery inductor LC.

The characteristics and mutual connection of these elements are nearly same as in the second power recovery circuit 6B (see FIG. 3A). However, a low potential terminal J3C of the third recovery capacitor CC is sustained at a potential substantially equal to a half (−Va/2) of a potential (−Va) of the negative potential terminal 4N.

The address pulse generating section 4C, merely shorts the path between the output terminal 4D of the second sustain pulse generating section 4B and the address electrode A during the sustain period (see FIG. 2). On the other hand, during reset and address periods, the address pulse generating section 4C may operate, for example, in the same manner as the prior art. Therefore, the detail of the address pulse generating section 4C is omitted.

During the sustain period, the first sustain pulse generating section 2A applies a first positive pulse voltage and a first negative pulse voltage to the scan electrode Y alternately as follows. On the other hand, the sustain electrode X is grounded through the grounding switch 3B (see FIG. 2). At this time, discharge continues in the discharge cell in which wall charge is accumulated during the address period, emitting light.

Further, the second sustain pulse generating section 4B applies a second pulse voltage with negative polarity to the address electrode A in synchronization with a first negative pulse voltage as follows. That is, when the scan electrode Y is sustained at negative potential −Vs, a voltage Vs−Va between the address electrode A and the scan electrode Y is lower than a voltage Vs between the sustain electrode X and the scan electrode Y. As a result, throughout the whole sustain period, discharge does not occur between the address electrode A and the other electrodes X and Y.

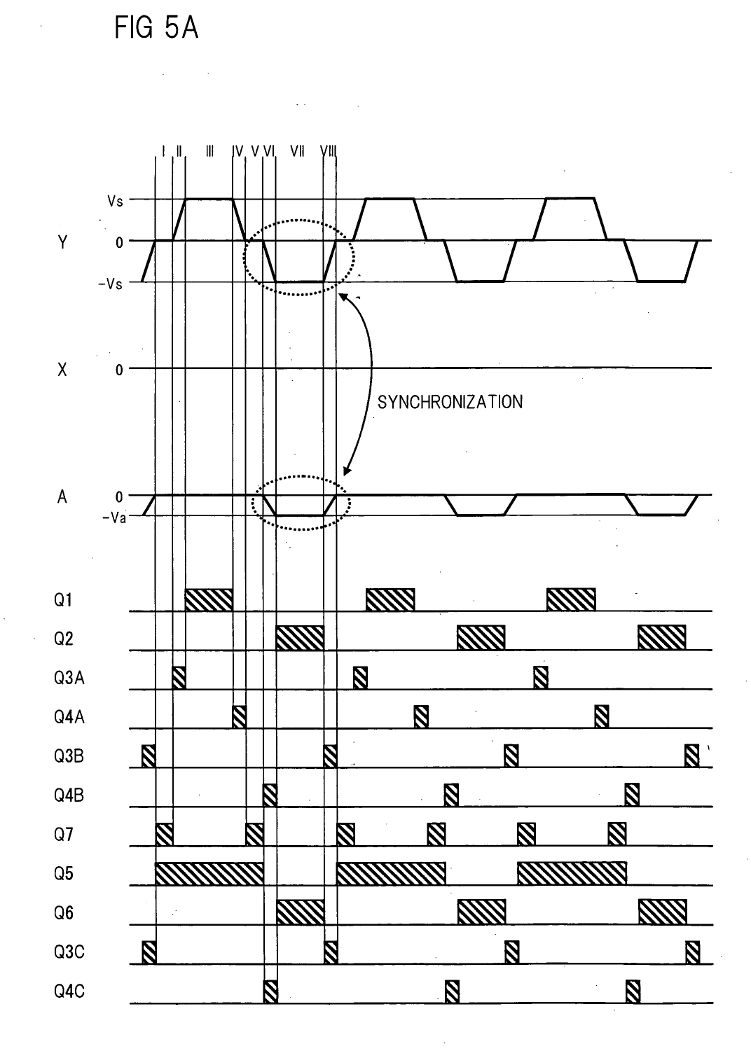

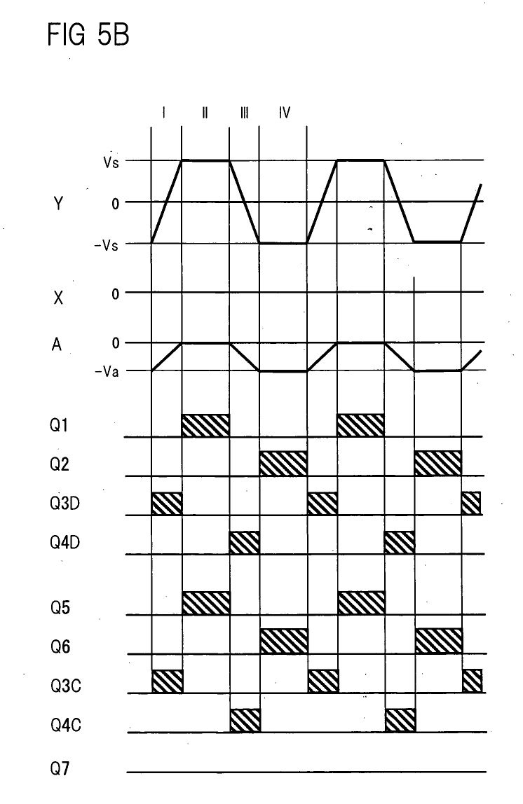

FIG. 5A is a waveform diagram showing potential changes in the scan electrode Y, the sustain electrode X and the address electrode A of the PDP 10 in the sustain period. It also shows ON periods of switch elements Q1, Q2, Q3A, Q4A, Q3B, Q4B and Q7 included in the first sustain pulse generating section 2A, and ON periods of switch elements Q5, Q6, Q3C and Q4C included in the second sustain pulse generating section 4B. In FIG. 5A, the ON period of each switch element is indicated by shaded area.

During the sustain period, the first reset/scan pulse generating section 2B shorts the path between the output terminal 2C of the first sustain pulse generating section 2A and the scan electrode Y, and the address pulse generating section 4C shorts the path between the output terminal 4D of the second sustain pulse generating section 4B and the address electrode A (see FIG. 2). Further, the sustain electrode driver 3 sustains the sustain electrode X at a ground potential.

In the sustain period, the following eight modes I to VIII are repeated (see FIG. 5A). Herein, modes II to IV correspond to an application period of the first positive pulse voltage, and modes VI to VIII correspond to an application period of the first negative pulse voltage and the second pulse voltage.

<Mode I>

In the first sustain pulse generating section 2A, only the bidirectional switch section Q7 is maintained in ON state, while the other switch elements Q1, Q2, Q3A, Q4A, and Q4B are maintained in OFF state (see FIG. 3A). As a result, the scan electrode Y is sustained in a ground potential (about 0).

In the second sustain pulse generating section 4B, the second high side sustain switch element Q5 is maintained in ON state, while the other switch elements Q6 and Q4C are maintained in OFF state (see FIG. 4). As a result, the address electrode A is sustained at a ground potential. In FIG. 5A, the switch element Q3B may be turned off in a period of the mode I, and the switch element Q3C may be turned off in a period of the modes I to V, although both switch elements Q3B and Q3C are being off during the periods.

<Mode II>

In the first sustain pulse generating section 2A, the bidirectional switch section Q7 is off, and the first high side recovery switch element Q3A is maintained on. As a result, the conduction path is formed in the sequence of: ground terminal→first recovery capacitor CA→first high side diode D1A→first high side recovery switch element Q3A→first recovery inductor LA→output terminal 2C (the arrow indicates the flow of the current; see FIG. 3A). Further, the conduction path is formed in the sequence of: output terminal 2C→panel capacity CXY between sustain electrodes X and Y→grounding switch 3B→ground terminal (the arrow indicates the flow of current; see FIG. 2).

In the second sustain pulse generating section 4B, the second high side sustain switch element Q5 is maintained in ON state, while the other switch elements Q6 and Q4C are maintained in OFF state (see FIG. 4). As a result, the conduction path is formed in the sequence of: output terminal 2C of the first sustain pulse generating section 2A→panel capacity CYA between scan electrode Y and address electrode A→output terminal 4D of the second sustain pulse generating section 4B→second high side sustain switch element Q5→high potential terminal 4G of the address electrode 4A→ground terminal (the arrow indicates the flow of current; see FIGS. 2 and 4).

At this time, a series circuit of the first recovery inductor LA and the panel capacity CXY between the sustain electrode X and the scan electrode Y, and a series circuit of the first recovery inductor LA and the panel capacity CYA between the scan electrode Y and the address electrode A individually receive a voltage Vs/2 from the first recovery capacitor CA, and resonate. Therefore, the potential of scan electrode Y increases smoothly.

<Mode III>

In the first sustain pulse generating section 2A, when a resonance current is attenuated substantially to zero, the first high side diode D1A is turned off. Further, the potential of the scan electrode Y reaches the potential +Vs (that is, the upper limit of sustain pulse voltage) of the positive potential terminal 1P of the DC-DC converter 1. At this time, the first high side sustain switch element Q1 is turned on (see FIG. 3A). As a result, the potential of the scan electrode Y is sustained at the upper limit +Vs of the sustain pulse voltage. In FIG. 5A, during a period of mode III, the first high side recovery switch element Q3A is off, but it may be turned from on to off in the period of mode III.

In the discharge cell of the PDP 10 in which wall charge is accumulated during the address period, since the wall voltage is added to the upper limit +Vs of the sustain pulse voltage, the voltage between the scan electrode Y and the sustain electrode X exceeds the firing voltage. Therefore, the discharge continues to emit light. At this time, the electric power for sustaining the discharge current is supplied from the DC-DC converter 1 to the PDP 10 by way of the positive potential terminal 1P and the first high side sustain switch element Q1.

In the second sustain pulse generating section 4B, the second high side sustain switch element Q5 is maintained in ON state, while the other switch elements Q6 and Q4C are maintained in OFF state (see FIG. 4). As a result, the address electrode A is sustained at a ground potential (about 0). At this time, the panel capacity CYA between the scan electrode Y and the address electrode A is charged with a charge corresponding to a voltage +Vs between both electrodes. That is, in the discharge cell of the PDP 10, a positive wall charge is accumulated particularly on the address electrode A side.

<Mode IV>

After the potential of the scan electrode Y is sustained at the upper limit +Vs of the sustain pulse voltage for a predetermined time, in the first sustain pulse generating section 2A, the first high side sustain switch element Q1 is turned off, and the first low side recovery switch element Q4A is turned on. As a result, the conduction path is formed in the sequence of: ground terminal←first recovery capacitor CA←first low side diode D2A←first low side recovery switch element Q4A←first recovery inductor LA←output terminal 2C (the arrow indicates the flow of current; see FIG. 3A). Further, the conduction path is formed in the sequence of: output terminal 2C←panel capacity CXY between sustain electrode X and scan electrode Y←grounding switch 3B←ground terminal (the arrow indicates the flow of current; see FIG. 2). In the second sustain pulse generating section 4B, the second high side sustain switch element Q5 is maintained in ON state, while the other switch elements Q6 and Q4C are maintained in OFF state (see FIG. 4). As a result, the conduction path is formed in the sequence of: output terminal 2C of the first sustain pulse generating section 2A←panel capacity CYA between the scan electrode Y and the address electrode A←output terminal 4D of the second sustain pulse generating section 4B←second high side sustain switch element Q5←high potential terminal 4G of the address power source 4A←ground terminal (the arrow indicates the flow of current; see FIG. 2, FIG. 4).

At this time, a series circuit of the first recovery inductor LA and the panel capacity CXY between the sustain electrode X and the scan electrode Y, and a series circuit of the first recovery inductor LA and the panel capacity CYA between the scan electrode Y and the address electrode A individually receive a voltage Vs/2 from the first recovery capacitor CA, and resonate. Therefore, the potential of the scan electrode Y declines smoothly.

<Mode V>

In the first sustain pulse generating section 2A, when the resonance current is attenuated substantially to zero, the first low side diode D2A is turned off. Further, the potential of the scan electrode Y reaches the ground potential (about 0). At this time, the bidirectional switch section Q7 is maintained on (see FIG. 3A). As a result, the scan electrode Y is sustained at the ground potential. In FIG. 5A, during a period of mode V, the first low side recovery switch element Q4A is off, but it may be turned from on to off during the period of mode V.

In the second sustain pulse generating section 4B, the second high side sustain switch element Q5 is maintained in ON state, while the other switch elements Q6 and Q4C are maintained in OFF state (see FIG. 4). As a result, the address electrode A is sustained at the ground potential.

<Mode VI>

In the first sustain pulse generating section 2A, the bidirectional switch section Q7 is off, and the second low side recovery switch element Q4B is maintained on. As a result, the loop is formed, which includes ground terminal←second recovery capacitor CB←second low side diode D2B←second low side recovery switch element Q4B←second recovery inductor LB←output terminal 2C←panel capacity CXY between the sustain electrode X and the scan electrode Y←grounding switch 3B←ground terminal (the arrow indicates the flow of current; see FIG. 2, FIG. 3).

At this time, a series circuit of the second recovery inductor LB and the panel capacity CXY between the sustain electrode X and the scan electrode Y receives a voltage −Vs/2 from the second recovery capacitor CB to resonate. Therefore, the potential of the scan electrode Y declines smoothly.

In the second sustain pulse generating section 4B, the second high side sustain switch element Q5 is off, and the third low side recovery switch element Q4C is maintained on (see FIG. 4). As a result, the loop is formed, which includes ground terminal→grounding switch 3B→panel capacity CXA between the sustain electrode X and the address electrode A→output terminal 4D of the second sustain pulse generating section 4B→the third recovery inductor LC→third low side recovery switch element Q4C→third low side diode D2C→third recovery capacitor CC→ground terminal (the arrow indicates the flow of current; see FIG. 2, FIG. 4).

At this time, a series circuit of the third recovery inductor LC and the panel capacity CXA between the sustain electrode X and the address electrode A receives a voltage −Va/2 from the third recovery capacitor CC, and resonates. Therefore, the potential of the address electrode A declines smoothly.

<Mode VII>

In the first sustain pulse generating section 2A, when the resonance current is attenuated substantially to zero, the second low side diode D2B is turned off. Further, the potential of the scan electrode Y reaches the potential −Vs of the negative potential terminal 1N of the DC-DC converter 1 (that is, the lower limit of the sustain pulse voltage). At this time, the first low side sustain switch element Q2 is turned on (see FIG. 3A). As a result, the potential of the scan electrode Y is sustained at the lower limit −Vs of the sustain pulse voltage. In FIG. 5A, during the mode VII, the second low side recovery switch element Q4B is off, but it may be turned from on to off in the mode VII.

In the discharge cell of the PDP 10 in which wall charge is accumulated in the address period, since the wall voltage is added to the lower limit −Vs of the sustain pulse voltage, the voltage between the scan electrode Y and the sustain electrode X exceeds the firing voltage. Therefore, discharge continues, and light is emitted. At this time, the electric power for sustaining the discharge current is supplied from the DC-DC converter 1 to the PDP 10 by way of the negative potential terminal 1N and the first low side sustain switch element Q2.

In the second sustain pulse generating section 4B, when the resonance current is attenuated substantially to zero, the third low side diode D2C is turned off. Further, the potential of the address electrode A reaches the potential −Va of the low potential terminal 4N of the address power source 4A. At this time, the second low side sustain switch element Q6 is turned on (see FIG. 4). As a result, the potential of the address electrode A is sustained at the potential −Va of the low potential terminal 4N. In FIG. 5A, during the mode VII, the third low side recovery switch element Q4C is off, but it may be changed from on to off in the period of mode VII.

Herein, the potential −Va of the address electrode A is lower than the ground potential (about 0) and higher than the potential −Vs of the scan electrode Y: −Vs≦−Va<0. Preferably, the potential −Va of the address electrode A is close to the potential −Vs of the scan electrode Y, thereby a positive wall charge can be maintained on the address electrode A side of the discharge cell.

<Mode VIII>

In the first sustain pulse generating section 2A, the first low side sustain switch element Q2 is off, and the second high side recovery switch element Q3B is maintained on. As a result, the loop is formed, which includes ground terminal→second recovery capacitor CB→second high side diode D1B→second high side recovery switch element Q3B→second recovery inductor LB→output terminal 2C→panel capacity CXY between the sustain electrode X and the scan electrode Y→grounding switch 3B→ground terminal (the arrow indicates the flow of current; see FIG. 2 and FIG. 3).

At this time, a series circuit of the second recovery inductor LB and the panel capacity CXY between the sustain electrode X and the scan electrode Y receives a voltage −Vs/2 from the second recovery capacitor CB, and resonates. Therefore, the potential of the scan electrode Y increases smoothly.

When the resonance current is attenuated substantially to zero, the second high side diode D1B is turned off, and the potential of the scan electrode Y reaches the ground potential (about 0). At this time, the bidirectional switch section Q7 is turned on, and the scan electrode Y is sustained at the ground potential. This is the same as in mode I (see FIG. 3A).

In the second sustain pulse generating section 4B, the second low side sustain switch element Q6 is turned off, and the third high side recovery switch element Q3C is turned on (see FIG. 4). As a result, the loop is formed, including ground terminal←grounding switch 3B←panel capacity CXA between the sustain electrode X and the address electrode A←output terminal 4D of the second sustain pulse generating section 4B←third recovery inductor LC←third high side recovery switch element Q4C←third high side diode D1C←third recovery capacitor CC←ground terminal (the arrow indicates the flow of current; see FIG. 2 and FIG. 4).

At this time, a series circuit of the third recovery inductor LC and the panel capacity CXA between the sustain electrode X and the address electrode A receives a voltage −Va/2 from the third recovery capacitor CC, and resonates. Therefore, the potential of address electrode A increases smoothly.

When the resonance current is attenuated substantially to zero, the third high side diode D1C is turned off, and the potential of the address electrode A reaches the ground potential (about 0). At this time, the second high side sustain switch element Q5 is turned on, and the address electrode A is sustained at the ground potential. This is same as mode I (see FIG. 3A).

In modes II and VI, the panel capacity CXY between the sustain electrode X and the scan electrode Y is charged. Electric power necessary for charging in each mode is supplied to the panel capacity CXY from the first recovery capacitor CA and second recovery capacitor CB. On the other hand, in modes IV and VIII, the panel capacity CXY between the sustain electrode X and the scan electrode Y is discharged. As a result, the electric power supplied in modes II and VI is recovered from the panel capacity CXY to the first recovery capacitor CA and second recovery capacitor CB.

Similarly, the electric power supplied from the third recovery capacitor CC to the panel capacity CXA in mode VI is recovered from the panel capacity CXA to the third recovery capacitor CC in mode VIII.

Thus, upon rise/fall of sustain pulse voltage, panel capacities CXY, CXA, CYA of the PDP 10 and recovery inductors LA, LB, and LC resonate, and electric power is exchanged efficiently between them. That is, when applying the sustain pulse voltage, reactive power due to charge or discharge of the panel capacity is decreased.

As described herein, in the PDP driving apparatus 30 of embodiment 1 of the invention, the sustain electrode driver 3 keeps the sustain electrode X grounded during the sustain period. That is, the potential of the sustain electrode X is fixed at a specific value. As a result, the sustain electrode driver 3 does not require a sustain pulse generating section.

In this embodiment, as shown in FIG. 5A, during the sustain period, a negative pulse is applied to the address electrode A in complete synchronization with a negative pulse of the scan electrode Y, but this is not particularly limited. For example, the potential of the address electrode A may be controlled to reach the minimum value (−Va) before the potential of the scan electrode Y reaches the minimum value (−Vs), and reach the maximum value (0) before the potential of the scan electrode Y reaches the maximum value (Vs).

During the sustain period, contrary to the example above, the scan electrode driver 2 grounds the scan electrode Y, that is, fixes the potential of the scan electrode Y at a constant value, and the sustain electrode driver 3 includes the first sustain pulse generating section 2A. In this case, the scan electrode driver 2 does not require a sustain pulse generating section.

Thus, during the sustain period, by grounding the sustain electrode X (or scan electrode Y) (fixing at a constant value), the sustain pulse generating section may be omitted in the sustain electrode driver 3 (or scan electrode driver 2). As a result, the area of the whole PDP driving apparatus can be saved by the portion of the sustain pulse generating section, so that the flexibility of circuit design may be enhanced. Accordingly, the PDP driving apparatus 30 in embodiment 1 of the invention can be easily reduced in size.

Incidentally, in the PDP driving apparatus disclosed in patent document 1, during the sustain period, the address electrode together with the sustain electrode is kept always at a ground potential. Accordingly, every time the scan electrode Y is sustained at positive potential or negative potential, discharge current flows from the address electrode side, which was contrary to saving of power of the PDP. Besides, at the address electrode side, since wall charge is not substantially left over, electron/ion impact on the phosphor layer is violent, and the phosphor is likely to be damaged, which was contrary to extension of service life of PDP. By contrast, in the PDP driving apparatus of this embodiment, the potential of the address electrode is not fixed at specific value but is changed depending on the potential of the scan electrode, and hence such problems of patent document 1 do not occur, as further discussed below.

In each discharge cell of the PDP 10, it is highly possible that a positive wall charge is accumulated on the address electrode A side upon start of sustain period.

The PDP driving apparatus 30 in embodiment 1 of the invention applies a second pulse voltage of negative polarity to the address electrode A, in synchronization with application of the first negative pulse voltage to the scan electrode Y, during the sustain period (see modes VI to VIII in FIG. 5A).

Hence, in the application period of the first negative pulse voltage, the voltage between the address electrode A and the scan electrode Y is lower than the voltage between the sustain electrode X and the scan electrode Y. Therefore, on the address electrode A side, erasure of positive wall charge is suppressed. That is, a discharge current does not flow in the address electrode A substantially. Further, on the address electrode A side, impact by electrons is decreased.

On the other hand, in application period of the first positive pulse voltage (see modes II to IV in FIG. 5A), the positive wall charge accumulated on the address electrode A side is maintained constant. That is, the discharge current does not flow in the address electrode A.

As a result, on the address electrode A side, throughout the entire sustain period, the positive wall charge is maintained constant. That is, the discharge current does not flow in the address electrode A substantially, and electron/ion impact is decreased on the address electrode A side.

Thus, according to the PDP driving apparatus 30 in embodiment 1 of the invention, the power consumption of the PDP 10 is reduced, and the service life of the PDP 10 is extended.

Incidentally, if it is highly possible that upon start of sustain period the polarity of wall charge accumulated on the address electrode A side is negative, the polarity of the second pulse voltage should be set positive. In this case, the second pulse voltage is applied to the address electrode A in synchronization with application of the first positive pulse voltage to the scan electrode Y.

Actually it is hard to specify the polarity of wall charge accumulated on the address electrode A side. Therefore, for example, by experiment, second pulse voltages having positive and negative polarities are actually applied during the sustain period, and amounts of discharge currents flowing in the address electrode A are compared. The polarity when the discharge current amount is smaller may be determined as the polarity of the second pulse voltage.

The second pulse voltage may be smaller in pulse width than the first positive/negative pulse voltage. The pulse width of the second pulse voltage preferably corresponds to the duration of one discharge in the discharge cell. In this case, the rise of the second pulse voltage may be synchronized with the rise of the first positive/negative pulse voltage.

As other preferred example of the first sustain pulse generating section 2A, an equivalent circuit diagram thereof is shown in FIG. 3B. The first sustain pulse generating section 2A includes a first high side sustain switch element Q1, a first low side sustain switch element Q2, a bidirectional switch section Q7, and a power recovery section 6D. The circuit of the power recovery section 6D includes a fourth recovery inductor LD, a fourth high side diode D1D, a fourth low side diode D2D, a fourth high side recovery switch element Q3D, and a fourth low side recovery switch element Q4D. What differs from power recovery sections 6A and 6B lies in that recovery capacitors CA and CB are deleted, and that the junction point J3D is grounded directly. Connection of other parts is the same. When using the power recovery section in FIG. 3B, the operation during sustain period is as shown in FIG. 5B.

<Mode I>

In the first sustain pulse generating section 2A, the bidirectional switch section Q7 is off, and the fourth high side recovery switch element Q3D is maintained on. As a result, the conduction path is formed, which includes ground terminal→fourth high side diode D1D→fourth high side recovery switch element Q3D→fourth recovery inductor LD→output terminal 2C (the arrow indicates the flow of current; see FIG. 3B). Further, the conduction path is formed, which includes output terminal 2C→panel capacity CXY between the sustain electrode X and the scan electrode Y→grounding switch 3B→ground terminal (the arrow indicates the flow of current; see FIG. 2). At this time, a series circuit of fourth recovery inductor LD and panel capacity CXY between the sustain electrode X and the scan electrode Y resonates. Therefore, the potential of the scan electrode Y increases smoothly.

In the second sustain pulse generating section 4B, the second low side sustain switch element Q6 is off, and the third high side recovery switch element Q3C is maintained on (see FIG. 4). As a result, the loop is formed, which includes ground terminal←grounding switch 3B←panel capacity CXA between sustain electrode X and address electrode A←output terminal 4D of second sustain pulse generating section 4B←third recovery inductor LC←third high side recovery switch element Q4C←third high side diode D1C←third recovery capacitor CC←ground terminal (the arrow indicates the flow of current; see FIG. 2, FIG. 4). At this time, a series circuit of the third recovery inductor LC and the panel capacity CXA between the sustain electrode X and the address electrode A receives a voltage −Va/2 from the third recovery capacitor CC, and resonates. Therefore, the potential of the address electrode A increases smoothly.

<Mode II>

In the first sustain pulse generating section 2A, when the resonance current is attenuated substantially to zero, the fourth high side diode D1D is turned off. Further, the potential of the scan electrode Y reaches the potential +Vs of the positive potential terminal 1P of the DC-DC converter 1 (that is, upper limit of sustain pulse voltage). At this time, the first high side sustain switch element Q1 is turned on (see FIG. 3B). As a result, the potential of the scan electrode Y is sustained at the upper limit +Vs of the sustain pulse voltage. In FIG. 5B, during the period of mode II, the fourth high side recovery switch element Q3D is off, but it may be turned from on to off in the period of mode II.

In the discharge cell of the PDP 10 in which wall charge is accumulated in the address period, since the wall voltage is added to the upper limit +Vs of the sustain pulse voltage, the voltage between the scan electrode Y and the sustain electrode X exceeds the firing voltage. Therefore, discharge continues, and light is emitted. At this time, the electric power for sustaining the discharge current is supplied from the DC-DC converter 1 to the PDP 10 by way of the positive potential terminal 1P and the first high side sustain switch element Q1.

In the second sustain pulse generating section 4B, the second high side sustain switch element Q5 is maintained in ON state, while the other switch elements Q6 and Q4C are maintained in OFF state (see FIG. 4). As a result, the address electrode A is sustained at the ground potential (about 0). In FIG. 5B, during the period of mode II, the third high side recovery switch element Q3C is off, but it may be turned from on to off during the period of mode II.

<Mode III>

In the first sustain pulse generating section 2A, the first high side sustain switch element Q1 is off, and the fourth low side recovery switch element Q4D is maintained on. As a result, the conduction path is formed, which includes ground terminal←fourth low side diode D2D←fourth low side recovery switch element Q4D←fourth recovery inductor LD←output terminal 2C (the arrow indicates the flow of current; see FIG. 3B). Further, the conduction path is formed, which includes output terminal 2C←panel capacity CXY between the sustain electrode X and the scan electrode Y←grounding switch 3B←ground terminal (the arrow indicates the flow of current; see FIG. 2). At this time, a series circuit of the fourth recovery inductor LD and the panel capacity CXY between the sustain electrode X and the scan electrode Y resonates. Therefore, the potential of the scan electrode Y declines smoothly.

In the second sustain pulse generating section 4B, the second high side sustain switch element Q5 is off, and the third low side recovery switch element Q4C is maintained on (see FIG. 4). As a result, the loop is formed which includes ground terminal→grounding switch 3B→panel capacity CXA between sustain electrode X and address electrode A→output terminal 4D of the second sustain pulse generating section 4B→third recovery inductor LC→third low side recovery switch element Q4C→third low side diode D2C→third recovery capacitor CC→ground terminal (the arrow indicates the flow of current; see FIG. 2, FIG. 4). At this time, a series circuit of the third recovery inductor LC and the panel capacity CXA between the sustain electrode X and the address electrode A receives the voltage −Va/2 from the third recovery capacitor CC, and resonates. Therefore, the potential of the address electrode A declines smoothly.

<Mode IV>

In the first sustain pulse generating section 2A, when the resonance current is attenuated substantially to zero, the fourth low side diode D2D is turned off. Further, the potential of the scan electrode Y reaches the potential −Vs of the negative potential terminal 1N of the DC-DC converter 1 (that is, lower limit of sustain pulse voltage). At this time, the first low side sustain switch element Q2 is maintained on (see FIG. 3B). Consequently, the potential of the scan electrode Y is sustained at the lower limit −Vs of the sustain pulse voltage. In FIG. 5B, during the period of mode IV, the fourth low side recovery switch element Q4D is off, but it may be turned from on to off during the period of mode IV.

In the discharge cell of the PDP 10 in which wall charge is accumulated in the address period, since the wall voltage is added to the lower limit −Vs of the sustain pulse voltage, the voltage between the scan electrode Y and sustain electrode X exceeds the firing voltage. Therefore, the discharge continues, and light is emitted. At this time, the electric power for sustaining the discharge current is supplied from the DC-DC converter 1 to the PDP 10 by way of the negative potential terminal 1N and the first low side sustain switch element Q2.

In the second sustain pulse generating section 4B, when the resonance current is attenuated substantially to zero, the third low side diode D2C is turned off. Further, the potential of the address electrode A reaches the potential −Va of the low potential terminal 4N of the address power source 4A. At this time, the second low side sustain switch element Q6 is turned on (see FIG. 4). As a result, the potential of the address electrode A is sustained at the potential −Va of the low potential terminal 4N. In FIG. 5B, during the period of mode IV, the third low side recovery switch element Q4C is off, but it may be changed from on to off during the period of mode IV.

Thus, upon rise/fall of sustain pulse voltage, panel capacities CXY, CXA and CYA of the PDP 10 and recovery inductors LA, LB and LC resonate, and the electric power is exchanged efficiently between them. That is, when applying the sustain pulse voltage, the reactive power due to charge or discharge of the panel capacity is decreased.

### Embodiment 2

In embodiment 1, structure and operation are explained about the PDP driving apparatus for driving while fixing the potential of the sustain electrode (or scan electrode) at a specific value during the sustain period. This embodiment relates to structure and operation of a PDP driving apparatus for driving while fixing the potential of the sustain electrode (or scan electrode) at a specific value during the reset period and the address period in addition to the sustain period. According to this embodiment, the circuit for driving the sustain electrode (or scan electrode) can be completely omitted, thereby reducing the PDP driving apparatus in size.

The plasma display in embodiment 2 of the invention is similar in structure to that in embodiment 1 (see FIG. 1). Its structure can be understood by referring to the explanation of embodiment 1 and FIG. 1.

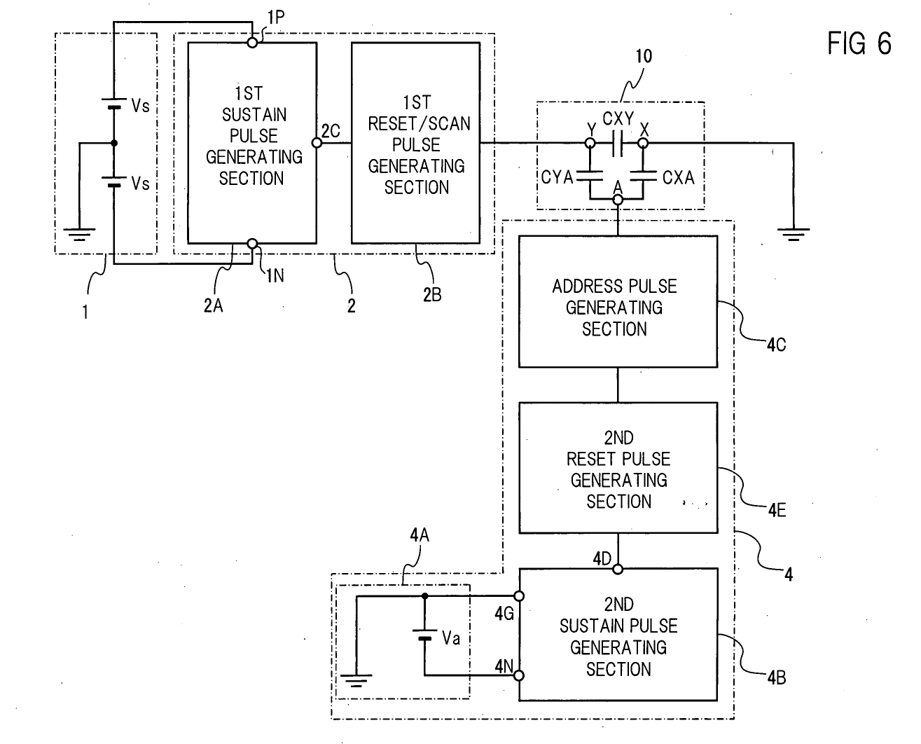

FIG. 6 is a block diagram of an equivalent circuit of the PDP 10 and the PDP driving apparatus 30 in embodiment 2 of the invention. In FIG. 2 and FIG. 6, similar elements are identified with the same reference numerals.

In embodiment 2 of the invention, unlike embodiment 1, the sustain electrode driver 3 does not include an reset/scan pulse generating section, but, instead, the address electrode driver 4 includes a second reset pulse generating section 4E. As a result, the sustain electrode driver 3 does not include any circuit substantially and is just a junction between the sustain electrode X and the ground terminal. That is, the sustain electrode X is always sustained at the ground potential (about 0).

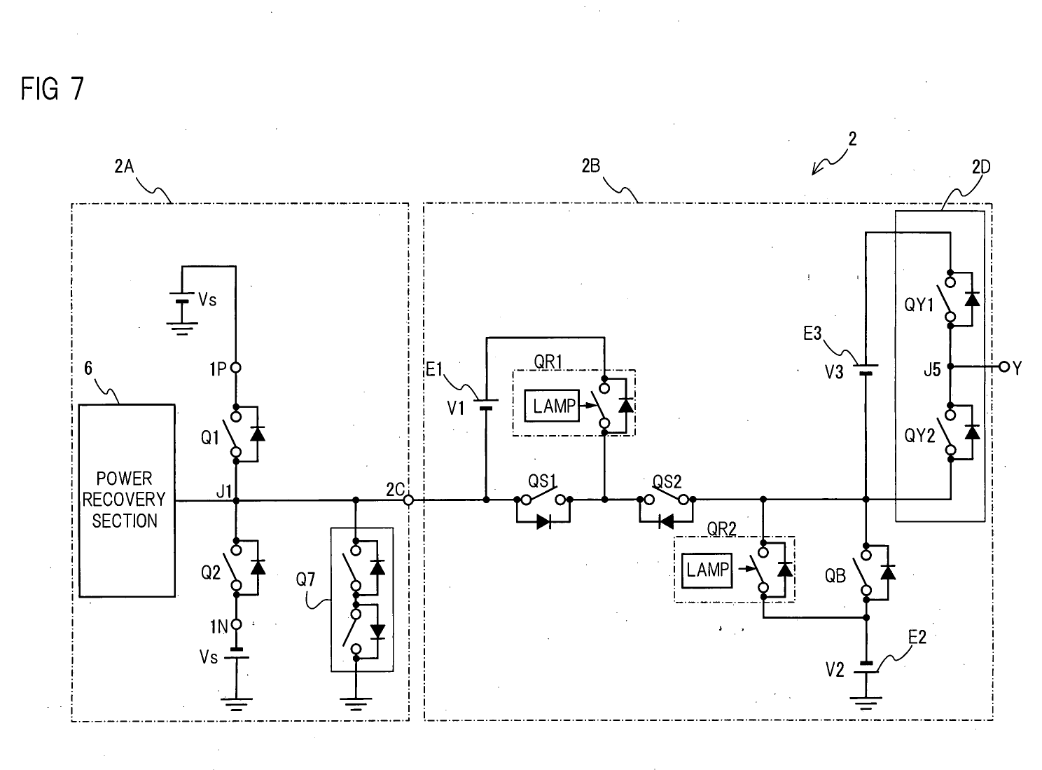

FIG. 7 is an equivalent circuit diagram of the scan electrode driver 2. The scan electrode driver 2 includes the first sustain pulse generating section 2A and the first reset/scan pulse generating section 2B.

The structure of this first sustain pulse generating section 2A is similar to that of the first sustain pulse generating section 2A in embodiment 1 (see FIG. 3A or FIG. 3B). Therefore, in FIG. 3A, FIG. 3B, and FIG. 7, similar elements are identified with the same reference numerals. Further, these similar elements are explained by citing the explanation about embodiment 1.

In particular, the circuit configuration of the power recovery section 6 is same as that in embodiment 1 (FIG. 3A or FIG. 3B). Therefore, in FIG. 7, the equivalent circuit of the power recovery section 6 is omitted. The equivalent circuit can be explained by citing the explanation about embodiment 1 and FIG. 3A or FIG. 3B.

The first reset/scan pulse generating section 2B includes three constant voltage sources E1, E2 and E3, two ramp waveform generators QR1 and QR2, two separation switch elements QS1 and QS2, a bypass switch QB, and a scan switch 2D.

The three constant voltage sources E1, E2 and E3 sustain the voltage between the positive and negative electrodes at constant values V1, V2 and V3, respectively, on the basis of the direct-current voltage applied from the DC-DC converter 1, for example.

Voltage V1 of the first constant voltage source E1 is equal to the difference between the upper limit of the reset pulse voltage and the potential +Vs of the positive potential terminal 1P. That is, (upper limit of reset pulse voltage)=Vs+V1.

Voltage V2 of the second constant voltage source E2 is reverse in polarity from the scan pulse voltage, and is equal in magnitude to the lower limit of the scan pulse voltage. That is, (lower limit of scan pulse voltage)=−V2. Herein, the lower limit of the reset pulse voltage is equal to that of the scan pulse voltage.

Voltage V3 of the third constant voltage source E3 is equal to amplitude of the scan pulse voltage (difference between upper limit and lower limit). That is, (upper limit of scan pulse voltage)=V3−V2.

The two ramp waveform generators QR1 and QR2 respectively include, for example, NMOS. The gate and drain of the NMOS are connected by a circuit including at least a capacitor. When the ramp waveform generators QR1 and QR2 are turned on, the voltage between the drain and source of each waveform generator substantially changes to zero at a specific speed.

The scan switches 2D are actually provided as many as the number of plural scan electrodes Y1, Y2, . . . (see FIG. 1), and connected individually to each one of scan electrodes Y1, Y2, . . . .

Each scan switch 2D includes a series circuit of a high side scan switch element QY1 and a low side scan switch element QY2.

The source of the high side scan switch element QY1 is connected to the drain of the low side scan switch element QY2. The junction point J5 is further connected to the corresponding scan electrode Y.

Two separation switch elements QS1 and QS2 are connected in series between the output terminal 2C of the first sustain pulse generating section 2A and the source of the low side scan switch element QY2. At the junction of these two separation switch elements QS1 and QS2, drains of those elements are connected commonly. The source of the first separation switch element QS1 is connected to the output terminal 2C of the first sustain pulse generating section 2A, and the source of second separation switch element QS2 is connected to the source of the low side scan switch element QY2.

During the sustain period, the two separation switch elements QS1 and QS2 and the low side scan switch element QY2 are turned on, and the output terminal 2C of the first sustain pulse generating section 2A and the scan electrode Y are shorted (see explanation about embodiment 1). At this time, a discharge current of the PDP 10 and a charge/discharge current due to the panel capacity flow through these switch elements QS1 and QS2, and QY2. Therefore, the two separation switch elements QS1 and QS2 are preferably large in current capacity. For example, each of separation switch elements QS1 and QS2 may include plural switch elements connected in parallel.

The negative electrode of the first constant voltage source E1 is connected to the source of the first separation switch element QS1, and the positive electrode is connected to the drain of the high side ramp waveform generator QR1. The source of the high side ramp waveform generator QR1 is connected to the drain of the first separation switch element QS1. That is, a series connection of the first constant voltage source E1 and the high side ramp waveform generator QR1 is connected in parallel to the first separation switch element QS1.

The positive electrode of the second constant voltage source E2 is grounded, and the negative electrode is connected to the sources of the low side ramp waveform generator QR2 and the bypass switch element QB. The drains of the low side ramp waveform generator QR2 and the bypass switch element QB are connected to the source of the low side scan switch element QY2. That is, the low side ramp waveform generator QR2 and the bypass switch element QB are connected between the source of the low side scan switch element QY2 and the negative electrode of the second constant voltage source E2, in parallel and with the same polarity. When the current capacity of the low side ramp waveform generator QR2 is sufficiently large, the bypass switch element QB may be omitted.

The positive electrode of the third constant voltage source E3 is connected to the drain of the high side scan switch element QY1, and the negative electrode is connected to the source of the low side scan switch element QY2.

The reset/scan pulse generating section 2B may be a circuit other than that with the configuration as described above. As far as the voltage necessary for resetting and scanning of the PDP 10 can be applied to the scan electrode, the invention is not limited to the circuit configuration of the reset/scan pulse generating section 2B.

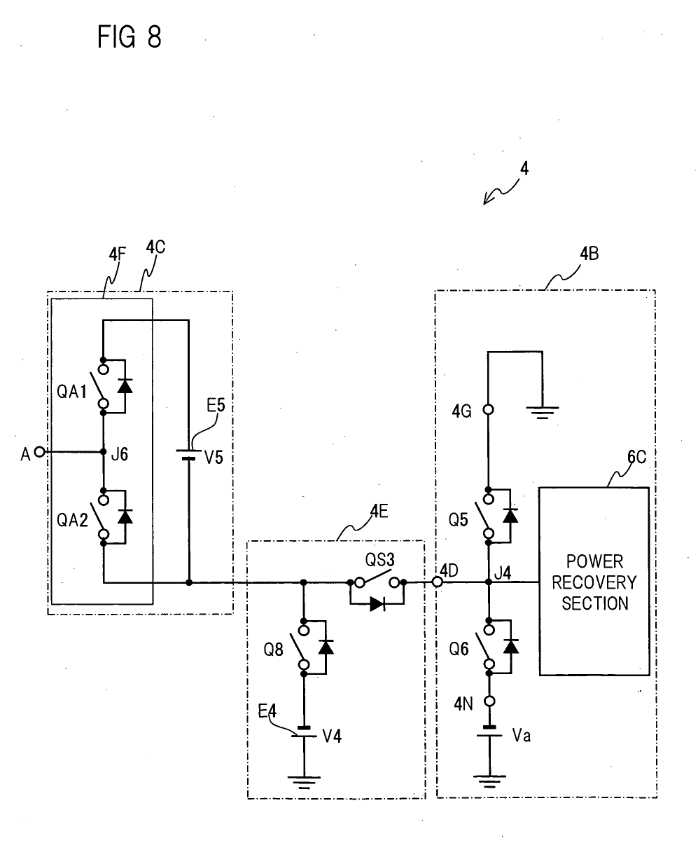

FIG. 8 is an equivalent circuit diagram of the address electrode driver 4.

The address electrode driver 4 includes a second sustain pulse generating section 4B, an address pulse generating section 4C, and a second reset pulse generating section 4E.

The structure of the second sustain pulse generating section 4B is same as that in embodiment 1 mentioned above (see FIG. 4). Therefore, in FIG. 4 and FIG. 8, similar elements are identified with the same reference numerals. These similar elements can be explained by citing the explanation of embodiment 1.

In particular, the structure of the third power recovery circuit 6C is same as that in embodiment 1 (see FIG. 4). In FIG. 8, therefore, an equivalent circuit of the third power recovery circuit 6C is not shown. Hence the equivalent circuit can be explained by citing the explanation about embodiment 1 and FIG. 4.

The second reset pulse generating section 4E includes a fourth constant voltage source E4, a third separation switch element QS3 as high side switch element, and a low side switch element Q8.

The address pulse generating section 4C includes a fifth constant voltage source E5 and an address switch section 4F.

Two constant voltage sources E4 and E5 sustain the voltage between the positive electrode and the negative electrode at specific values V4 and V5, respectively, for example, on the basis of the direct-current voltage applied from the DC-DC converter 1.

Voltage V4 of the fourth constant voltage source E4 is reverse in polarity from the address pulse voltage, and is identical in magnitude with the lower limit of the address pulse voltage. That is, (lower limit of address pulse voltage)=−V4.

Voltage V4 of the fourth constant voltage source E4 may be either higher or lower than the output voltage Va of the address power source 4A (see FIG. 6). In FIG. 8, voltage V4 of the fourth constant voltage source E4 is higher than the output voltage Va of the address power source 4A: V4>Va.

Voltage V5 of the fifth constant voltage source E5 is equal to the amplitude of the address pulse voltage (difference between upper limit and lower limit). That is, (upper limit of address pulse voltage)=V5−V4. Specifically the voltage V5 of the fifth constant voltage source E5 is lower than the voltage V4 of the fourth constant voltage source E4: V5<V4. Hence, the upper limit of the address pulse voltage is negative.

The third separation switch element QS3 and the low side switch element Q8 are, for example, MOS FETs. They may be also IGBT or bipolar transistors.

Plural address switch sections 4F are actually provided as many as the number of plural address electrodes A1, A2, . . . (see FIG. 1), and are connected individually to each of address electrodes A1, A2 . . . .

Each address switch section 4F includes a series circuit of a high side address switch element QA1 and a low side address switch element QA2.

The two address switch elements QA1 and QA2 are, for example, MOS FETs. They may be also IGBT or bipolar transistors.

The source of the high side address switch element QA1 is connected to the drain of the low side address switch element QA2. The junction point J6 is further connected to the corresponding address electrode A.

The positive electrode of the fifth constant voltage source E5 is connected to the drain of the high side address switch element QA1, and the negative electrode is connected to the source of the low side address switch element QA2.

When the voltage V4 of the fourth constant voltage source E4 is higher than the output voltage Va of the address power source 4A (V4→Va), as shown in FIG. 8, the source of the third separation switch element QS3 is connected to the source of the low side address switch element QA2, and the drain is connected to the output terminal 4D of the second sustain pulse generating section 4B. In the sustain period, the third separation switch element QS3 and the low side address switch element QA2 are turned on, thereby the output terminal 4D of the second sustain pulse generating section 4B and the address electrode A are shorted (see explanation about embodiment 1).

The positive electrode of the fourth constant voltage source E4 is grounded, and the negative electrode is connected to the source of the low side switch element Q8. The drain of the low side switch element Q8 is connected to the source of the third separation switch element QS3.

When the voltage V4 of the fourth constant voltage source E4 is lower than the output voltage Va of the address power source 4A (V4<Va), unlike the case in FIG. 8, the path between the source of the low side address switch element QA2 and the output terminal 4D of the second sustain pulse generating section 4B (not shown) is shorted.

Further, the third separation switch element QS3 and the low side switch Q8 are connected in series in mutually reverse polarity to form a bidirectional switch. This bidirectional switch is connected between the negative electrode of the fourth constant voltage source E4 and the source of low side address switch element QA2 (not shown).

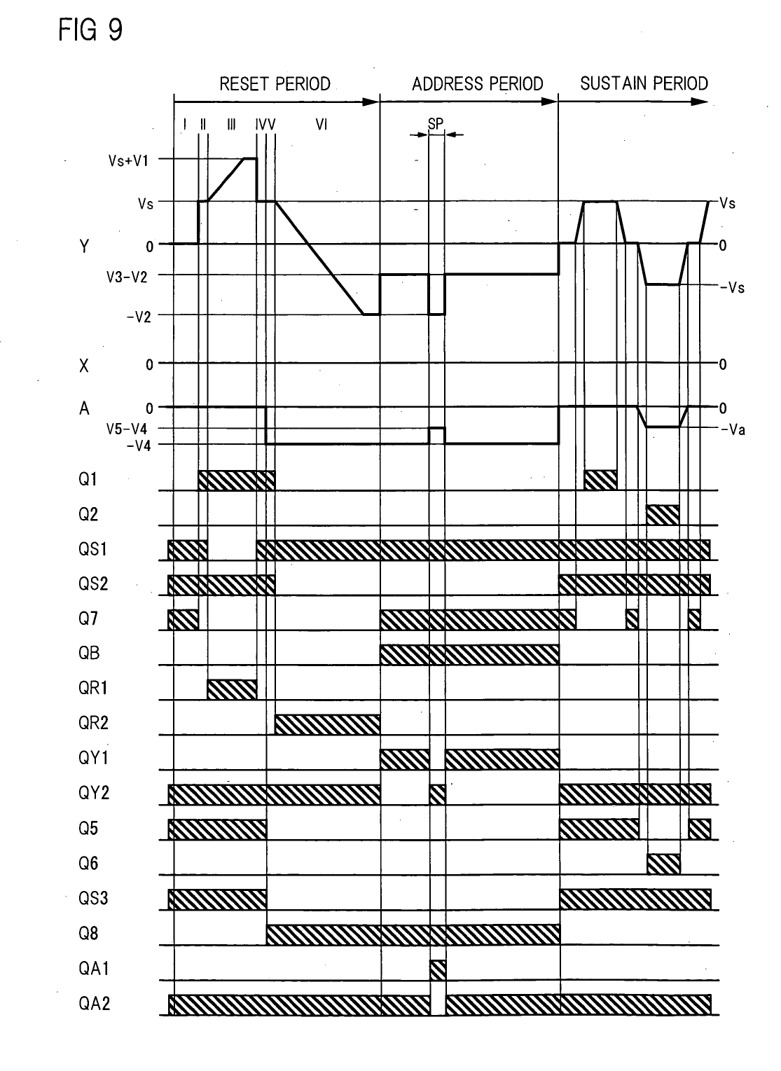

FIG. 9 is a waveform diagram showing potential changes in the scan electrode Y, the sustain electrode X and the address electrode A of the PDP 10 during the reset period, address period, and sustain period. It also shows ON periods of switch elements Q1, Q2, QS1, QS2, Q7, QB, QR1, QR2, QY1, and QY2 included in the scan electrode driver 2, and ON periods of switch elements Q5, Q6, QS3, Q8, QA1, and QA2 included in the address electrode driver 4 in embodiment 2 of the invention. In FIG. 9, the ON period of switch elements is indicated by shaded area.

Herein, suppose the voltage V4 of the fourth constant voltage source E4 is higher than the output voltage Va of the address power source 4A (V4>Va). If the voltage V4 of the fourth constant voltage source E4 is lower than the output voltage Va of the address power source 4A (V4<Va), the ON period of the third separation switch element QS3 coincides with that of the low side switch element Q8 shown in FIG. 9.

In the PDP driving apparatus 30 in embodiment 2 of the invention, unlike the conventional driving apparatus, the sustain electrode X is always sustained at the ground potential (about 0).

During the reset period, the potential of the scan electrode Y and the address electrode A vary by application of the reset pulse voltage.

Depending on change in reset pulse voltage, the reset period is divided into six modes as follows.

<Mode I>

In the scan electrode driver 2, two separation switches QS1 and QS2, the bidirectional switch Q7, and the low side scan switch element QY2 are maintained in ON state, and the other switch elements are maintained in OFF state (see FIG. 7). As a result, the scan electrode Y is sustained at the ground potential (about 0).

In the address electrode driver 4, the second high side sustain switch element Q5, the third separation switch element QS3, and the low side address switch element QA2 are maintained in ON state. The other switches are maintained in OFF state (see FIG. 8). As a result, the address electrode A is sustained at the ground potential.

<Mode II>

In the scan electrode driver 2, the first high side sustain switch element Q1 is turned on, and the bidirectional switch Q7 is turned off. At this time, two separation switches QS1 and QS2 and the low side scan switch element QY2 are maintained in ON state, and the remaining switch elements are maintained in OFF state. As a result, the potential of the scan electrode Y increases up to the potential +Vs of the positive potential terminal 1P.

In the address electrode driver 4, the state in mode I is sustained. As a result, the address electrode A is sustained at the ground potential (about 0).

<Mode III>

In the scan electrode driver 2, the first separation switch element QS1 is maintained off and the high side ramp waveform generator QR1 is maintained on. At this time, the first high side sustain switch element Q1, the second separation switch element QS2, and the low side scan switch element QY2 are maintained in ON state, and the remaining switch elements are maintained in OFF state. As a result, the potential of the scan electrode Y increases from the potential +Vs of the positive potential terminal 1P to the upper limit Vs+V1 of the reset pulse voltage at a specific speed.

In the address electrode driver 4, the state in mode I is sustained. As a result, the address electrode A is sustained at the ground potential (about 0).

Thus, in all discharge cells of the PDP 10, uniformly, the application voltage increases relatively slowly to the upper limit Vs+V1 of the reset pulse voltage. As a result, a uniform wall charge is accumulated. At this time, since the elevation speed of the application voltage is small, light emission from discharge cells is suppressed very low.

<Mode IV>

In the scan electrode driver 2, the first separation switch element QS1 is maintained on and the high side ramp waveform generator QR1 is off. At this time, the first high side sustain switch element Q1, the second separation switch element QS2, and the low side scan switch element QY2 are maintained in ON state, and the remaining switch elements are maintained in OFF state. As a result, the potential of the scan electrode Y declines to the potential +Vs of the positive potential terminal 1P.

In the address electrode driver 4, the state in mode I is sustained. As a result, the address electrode A is sustained at the ground potential (about 0).

Thus, in all discharge cells of the PDP 10, discharge stops, and weak light emission ceases.

<Mode V>

In the scan electrode driver 2, the state in mode IV is sustained. Therefore, the potential of the scan electrode Y is sustained at the potential +Vs of the positive potential terminal 1P.

In the address electrode driver 4, the second high side sustain switch element Q5 and the third separation switch element QS3 are off, and the low side switch element Q8 is maintained on. At this time, the low side address switch element QA2 is maintained in ON state, and the remaining switch elements are maintained in OFF state. As a result, the potential of the address electrode A declines to the lower limit −V4 of the address pulse voltage. Herein, the lower limit −V4 of the address pulse voltage is determined so that the discharge may not occur between the address electrode A and the other electrodes.

<Mode VI>

In the scan electrode driver 2, the first high side sustain switch element Q1 and the second separation switch element QS2 are off, and the low side ramp waveform generator QR2 is maintained on. At this time, the first separation switch element QS1 and the low side scan switch element QY2 are maintained in ON state, and the remaining switch elements are maintained in OFF state. As a result, the potential of the scan electrode Y declines from the potential +Vs of the positive potential terminal 1P to the lower limit −Vs of the reset pulse voltage at a specific speed.

In the address electrode driver 4, the state in mode V is sustained. As a result, the address electrode A is sustained at the lower limit −V4 of the address pulse voltage.

Thus, in discharge cells of the PDP 10, the voltage in reverse polarity from the application voltage in modes II to V is applied. As a result, in all discharge cells, wall charge is uniformly removed, and is unified. At this time, application voltage declines relatively slowly, and light emission from discharge cells is suppressed very low.

In particular, since the address electrode A sustained at the negative potential −V4, impact by electrons is suppressed on the address electrode A side of the discharge cell.

In address period, in the scan electrode driver 2, low side ramp waveform generator QR2 is off, and the bypass switch element QB is maintained on. As a result, the source (or emitter) of low side scan switch element QY2 is sustained at the lower limit −V2 of the scan pulse voltage. Further, for example, the bidirectional switch section Q7 is maintained on. At this time, the first separation switch element Q1 is maintained in ON state.

In the address electrode driver 4, the low side switch element Q8 is maintained in ON state, and the third separation switch element QS3 is maintained in OFF state. As a result, the source (or emitter) of the low side address switch element QA2 is sustained at the lower limit −V4 of the address pulse voltage.

Upon start of the address period, the scan electrode driver 2 maintains the high side scan switch element QY1 in ON state, and maintains the low side scan switch element QY2 in OFF state, in all of scan electrodes Y1, Y2, Y3, . . . (see FIG. 1). As a result, the potential of all scan electrodes Y is uniformly sustained at the upper limit V3−V2 of the scan pulse voltage.

The scan electrode driver 2, successively, changes the respective potentials of scan electrodes Y1, Y2, Y3, . . . , sequentially as follows (see scan pulse voltage SP in FIG. 9). When one electrode Y of the scan electrodes is selected, the high side scan switch element QY1 connected to this scan electrode Y is turned off, and the low side scan switch element QY2 is turned on. As a result, the potential of the scan electrode Y declines to the lower limit −V2 of the scan pulse voltage. When this potential of the scan electrode Y is sustained at the lower limit −V2 of the scan pulse voltage for a predetermined time, the low side scan switch element QY2 connected to this scan electrode Y is turned off, and the high side scan switch element QY1 is turned on. As a result, the potential of the scan electrode Y increases to the upper limit V3−V2 of the scan pulse voltage.

The scan electrode driver 2 successively performs similar switching operation on scan switch element pairs Q1Y and Q2Y connected to scan electrodes Y1, Y2, Y3, . . . Thus, the scan pulse voltage SP is sequentially applied to scan electrodes Y1, Y2, Y3, . . . .

Upon start of the address period, the address electrode driver 4 maintains the low side address switch element QA2 in ON state, and maintains the high side address switch element QA1 in OFF state, in all of address electrodes A1, A2, A3, . . . (see FIG. 1). As a result, the potential of all address electrodes A is sustained at the lower limit −4V of the address pulse voltage. At this time, the voltage V3−V2+v4 is sustained between the scan electrode Y and the address electrode A, which corresponds to difference between the upper limit V3−V2 of the scan pulse voltage and the lower limit −V4 of the address pulse voltage.

In the address period, the address electrode driver 4 selects one electrode A of the address electrodes on the basis of the video signal entered from outside, and increases the potential of the selected address electrode A to the upper limit V5−V4 of the address pulse voltage for a predetermined time.

For example, in interval SP shown in FIG. 9, when the scan pulse voltage is applied to one electrode Y of the scan electrodes, at the same time, the address pulse voltage is applied to one electrode A of the address electrodes. At this time, the voltage −V2+V4−V5 is applied between the scan electrode Y and the address electrode A, which corresponds to difference between the lower limit −V2 of the scan pulse voltage and the upper limit V5−V4 of the address pulse voltage. This voltage is higher than the voltage among other combinations of scan electrodes and address electrodes. Therefore, in the discharge cell located at the intersection of the scan electrode Y and the address electrode A selected simultaneously in the interval SP, discharge occurs between the scan electrode Y and the address electrode A. As a result, a more wall charge than in the other discharge cells is accumulated on the scan electrode Y of this discharge cell.

In the sustain period, the scan electrode driver 2 maintains two separation switch elements QS1 and QS2 and the low side scan switch element QY2 in ON state. As a result, the path between output terminal 2C of the first sustain pulse generating section 2A and the scan electrode Y is shorted. On the other hand, the address electrode driver 4 maintains the third separation switch element QS3 and the low side address switch element QA2 in ON state. As a result, the path between the output terminal 4D of the second sustain pulse generating section 4B and the address electrode A is shorted.

In this state, the first sustain pulse generating section 2A and the second sustain pulse generating section 4B operate in the same manner as in embodiment 1 so that the sustain pulse voltage is applied to the scan electrode Y and the address electrode A same as in embodiment 1 (see FIG. 5A). At this time, in the discharge cell in which a relatively large amount of wall charge is accumulated in the address period, the discharge continues to emit light.

As described herein, in the PDP driving apparatus 30 in embodiment 2 of the invention, the sustain electrode X is always sustained at the ground potential. That is, the sustain electrode driver 3 serves only as junction between the sustain electrode X and the ground terminal. Instead, the address electrode driver 4 should include both the second sustain pulse generating section 4B and the second reset pulse generating section 4E, in addition to the address pulse generating section 4C.

Thus, a driving circuit for driving the potential of the sustain electrode X can be completely omitted, and the circuit scale can be further reduced as compared with embodiment 1. Moreover, each pulse voltage generators and the power source can be gathered and disposed on the scan electrode Y side of the PDP 10. That is, the noise source and heat source of the PDP driving apparatus 30 are collected on the scan electrode Y side of the PDP 10, thereby providing easier measures against noise and heat.

For example, high frequency circuits, such as tuners, relatively less resistant to noise may be disposed on the sustain electrode X side of the PDP 10. At this time, adverse effects by noise from the PDP driving apparatus 30 can be effectively evaded.

Further, a cooling range by fan and other cooling devices may be limited to the scan electrode Y side of the PDP 10, thereby enhancing the cooling efficiency.

FIG. 9, shows the waveform assuming the recovery circuit section shown in FIG. 3A, as the waveform during the sustain period. But the recovery circuit section shown in FIG. 3B may be also used. In such a case, the voltage waveform and the on/off state of switch elements in the sustain period are as shown in FIG. 5B.

### Embodiment 3

In embodiments 1 and 2, while fixing the potential of the sustain electrode (or scan electrode) at a specific value during the sustain period, a pulse voltage of negative polarity is applied to the address electrode A. In this embodiment, while applying a pulse voltage of positive polarity to the address electrode A, the potential of the sustain electrode (or scan electrode) is fixed at a specific value during the sustain period.

The plasma display in embodiment 3 of the invention is similar to the plasma display in embodiment 1 (see FIG. 1) in structure. The structure can be explained by citing the descriptions in embodiment 1 and FIG. 1.

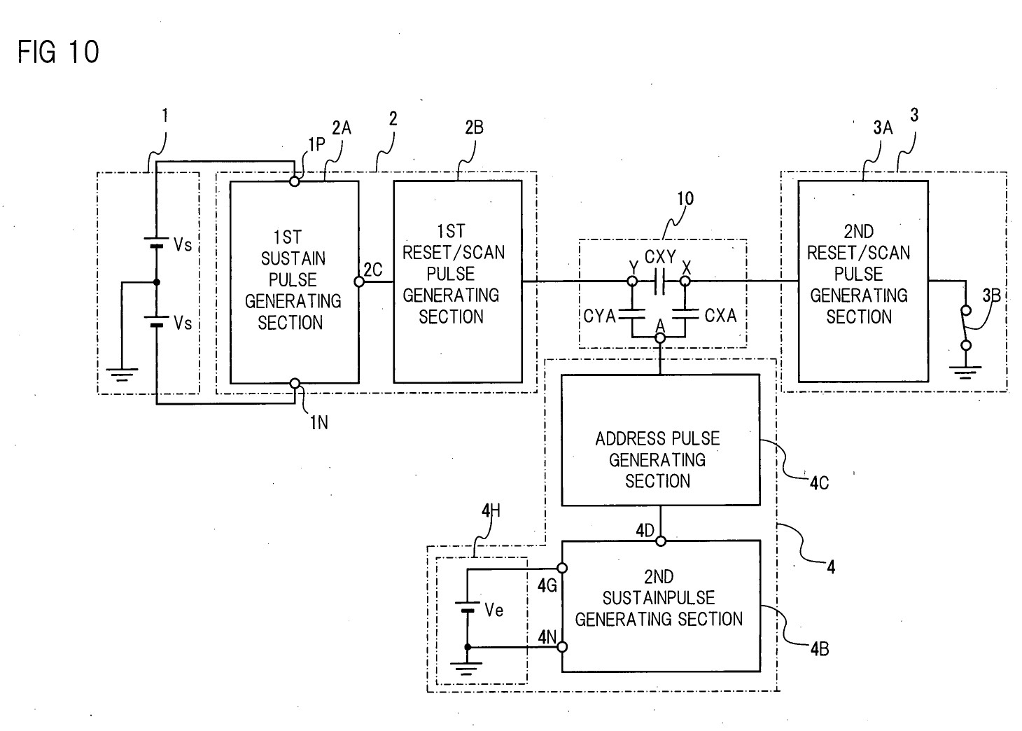

FIG. 10 is a block diagram of an equivalent circuit of the PDP 10 and the PDP driving apparatus 30 in embodiment 3 of the invention. In FIG. 2 and FIG. 10, similar elements are identified with same reference numerals.

In embodiment 3 of the invention, the grounding reference of voltage applied to the second sustain pulse generating section 4B included in the address electrode driver 4 is different from that in embodiment 1. That is, an address power source 4H is a positive direct-current voltage source, or a high potential terminal 4G is set at the specific positive potential Ve, and the low potential terminal 4N is sustained at the ground potential.

A specific circuit configuration of the second sustain pulse generating section 4B is the same as shown in FIG. 4, and canb e explained by citing the descriptions in embodiment 1 and FIG. 4. What differs from embodiment 1 is that the voltages applied to the high potential terminal 4G and the low potential terminal 4N are different, and hence the potential of recovery capacitor CC is substantially Ve/2.

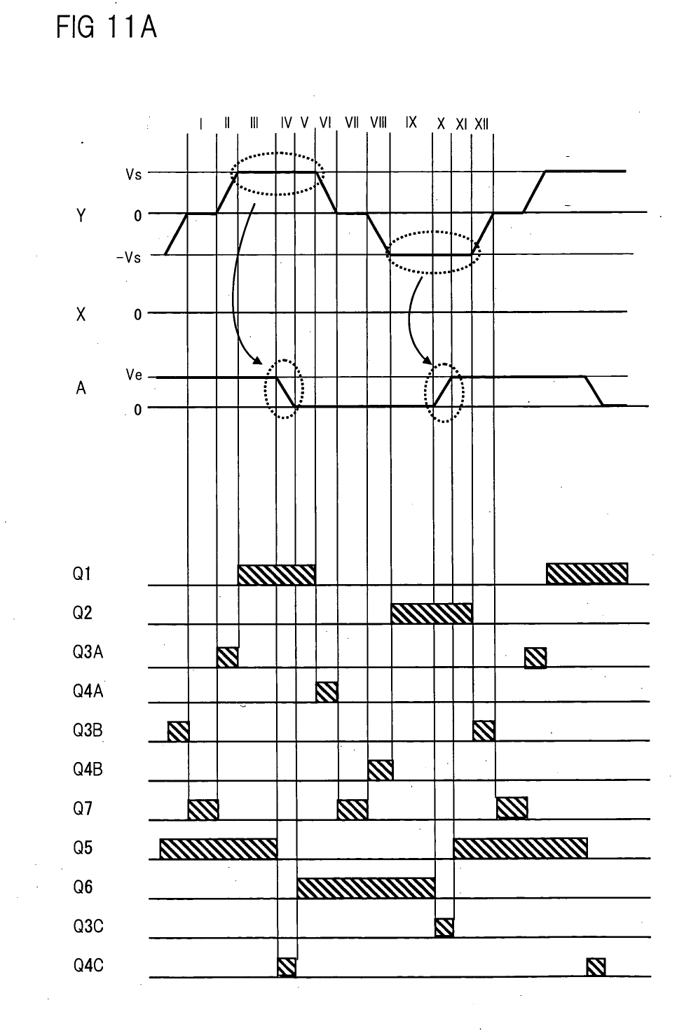

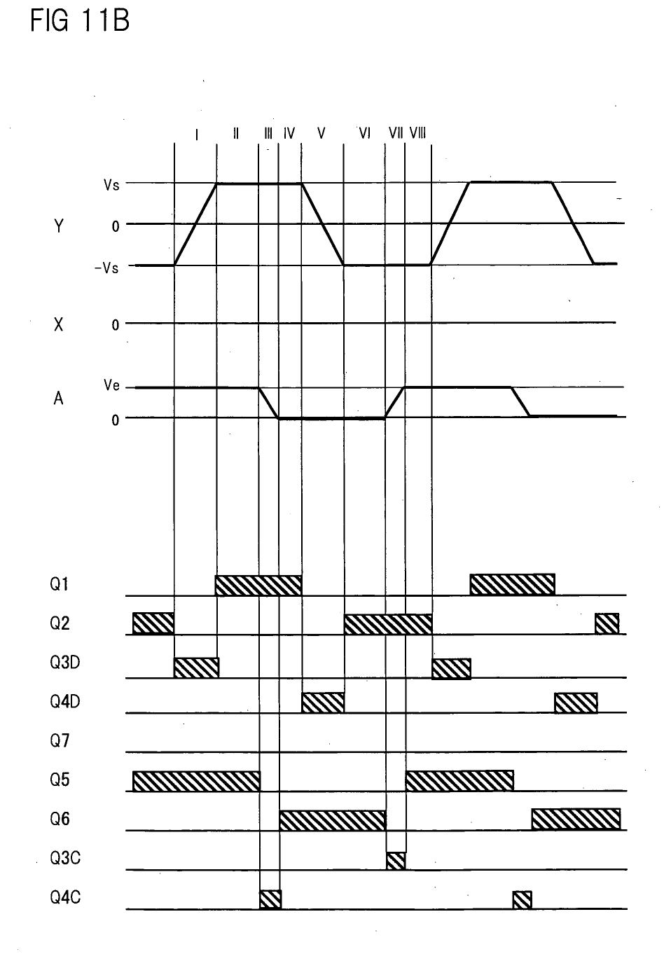

FIG. 11A shows specific operation and voltage waveforms applied to the PDP 10 during the sustain discharge period of the second sustain pulse generating section 4B, when the circuit configuration of the first sustain pulse generating section 2A is similar to FIG. 3A in embodiment 1.

As shown in FIG. 1A, in this embodiment, in the sustain discharge period, the potential of the sustain electrode X is controlled at the ground potential, and the potential of the address electrode A is controlled at either one of the positive potential Ve and the ground potential 0 depending on potential changes of the scan electrode Y. More specifically, while the potential of the scan electrode Y is at maximum value (Vs), the potential of the address electrode A is changed from the positive potential Ve to the ground potential 0. While the potential of the scan electrode Y is at minimum value (−Vs), the potential of the address electrode A is changed from the ground potential 0 to the positive potential Ve. The potential of the address electrode A may be changed so as to reach the ground potential 0 from the positive potential Ve during a period of change of potential of the scan electrode Y rising from the minimum value (−Vs) till falling again to the minimum value (−Vs), and to reach positive potential Ve from the ground potential 0 in a period of change of potential of scan electrode Y from minimum value (−Vs) till reaching maximum value (Vs). For example, in FIG. 11A, the potential of the address electrode A may be changed to move from the positive potential Ve to the ground potential 0 in a period from mode XII to mode VIII, and to move from the ground potential 0 to the positive potential Ve in a period from IX to mode II.

Depending on the changes of applied voltage, the operation is divided into twelve modes I to XII as explained below.

<Mode I>

In the first sustain pulse generating section 2A, the bidirectional switch section Q7 is maintained in ON state, while the first high side sustain switch element Q1, the first low side sustain switch element Q2, the first high side recovery switch element Q3A, the second high side recovery switch element Q4A, and the second low side recovery switch element Q4B are maintained in OFF state (see FIG. 3A). As a result, the scan electrode Y is sustained at the ground potential (about 0).

In the second sustain pulse generating section 4B, the second high side sustain switch element Q5 is maintained in ON state, while the second low side sustain switch element Q6, and the third high side recovery switch element Q4C are maintained in OFF state (see FIG. 4). As a result, the address electrode A is sustained at the high potential (about Ve). In FIG. 1A, the second high side recovery switch element Q3B and the third high side recovery switch element Q3C are off, but they may be also on. The second high side recovery switch element Q3B may be turned off anytime by the end of mode VII, and may be turned off anytime between mode I and mode VII. The third high side recovery switch element Q3C may be turned off anytime by the end of mode III, and may be turned off anytime between mode I, and mode III, XI or XII.

<Mode II>

In the first sustain pulse generating section 2A, the bidirectional switch section Q7 is off, and first high side recovery switch element Q3A is maintained on. As a result, the conduction path is formed, including ground terminal→first recovery capacitor CA→first high side diode D1A→first high side recovery switch element Q3A→first recovery inductor LA→output terminal 2C (the arrow indicates the flow of current; see FIG. 3A). Further, the conduction path is formed, including output terminal 2C→panel capacity CXY between sustain electrode X and scan electrode Y→grounding switch 3B→ground terminal (the arrow indicates the flow of current; see FIG. 10). At this time, a series circuit of the first recovery inductor LA and panel capacity CXY between the sustain electrode X and the scan electrode Y receives the voltage Vs/2 from the first recovery capacitor CA, and resonates. Therefore, the potential of the scan electrode Y increases smoothly. The second sustain pulse generating section 4B operates in the same manner as in mode I.

<Mode III>

In the first sustain pulse generating section 2A, when the resonance current is attenuated substantially to zero, the first high side diode D1A is turned off. Further, the potential of the scan electrode Y reaches the potential +Vs of the positive potential terminal 1P of the DC-DC converter 1 (that is, the upper limit of sustain pulse voltage). At this time, the first high side sustain switch element Q1 is turned on (see FIG. 3A). As a result, the potential of the scan electrode Y is sustained at the upper limit +Vs of the sustain pulse voltage. In FIG. 11A, the first high side recovery switch element Q3A is off, but it may be on. The first high side recovery switch element Q3A may be turned off anytime by the end of mode V, and it may be turned off anytime between mode III and mode V.

The second sustain pulse generating section 4B operates in the same manner as in mode I.

In the discharge cell of the PDP 10 in which wall charge is accumulated during the address period, since the wall voltage is added to the upper limit +Vs of the sustain pulse voltage, the voltage between the scan electrode Y and the sustain electrode X exceeds the firing voltage. Therefore, discharge continues to emit light. At this time, the electric power for sustaining the discharge current is supplied from the DC-DC converter 1 to the PDP 10 by way of the positive potential terminal 1P and the first high side sustain switch element Q1.

<Mode IV>

In the first sustain pulse generating section 2A, the operation is same as in mode III, but the discharge has been terminated. In the second sustain pulse generating section 4B, the second high side sustain switch element Q5 is off, and the third low side recovery switch element Q4C is maintained on (see FIG. 4). As a result, the loop is formed, including ground terminal→grounding switch 3B→panel capacity CXA between sustain electrode X and address electrode A→output terminal 4D of second sustain pulse generating section 4B→third recovery inductor LC→third low side recovery switch element Q4C→third low side diode D2C→third recovery capacitor CC→ground terminal (the arrow indicates the flow of current; see FIG. 10, FIG. 4). At this time, a series circuit of the third recovery inductor LC and the panel capacity CXA between sustain electrode X and address electrode A receives the voltage Ve/2 from the third recovery capacitor CC to resonate. Therefore, the potential of the address electrode A declines smoothly.

<Mode V>

In the first sustain pulse generating section 2A, the operation is same as in mode IV. In the second sustain pulse generating section 4B, when the resonance current is attenuated substantially to zero, the third low side diode D2C is turned off. Further, the potential of address electrode A reaches the potential of the low potential terminal 4N of the address power source 4H, that is, the ground potential. At this time, the second low side sustain switch element Q6 is turned on (see FIG. 4). As a result, the potential of the address electrode A is sustained at the ground potential. In FIG. 11A, the third low side recovery switch element Q4C is maintained off during the period of mode V, but it may be on. The third low side recovery switch element Q4C may be turned off anytime by the end of mode IX, and it may be turned off anytime between mode V and mode IX.

<Mode VI>

After the potential of the scan electrode Y is sustained at the upper limit +Vs of the sustain pulse voltage for a predetermined time, in the first sustain pulse generating section 2A, the first high side sustain switch element Q1 is turned off, and the first low side recovery switch element Q4A is turned on. As a result, the conduction path is formed, including ground terminal←first recovery capacitor CA←first low side diode D2A←first low side recovery switch element Q4A←first recovery inductor LA←output terminal 2C (the arrow indicates the flow of current; see FIG. 3A). Further, the conduction path is formed, including output terminal 2C←panel capacity CXY between sustain electrode X and scan electrode Y←grounding switch 3B←ground terminal (the arrow indicates the flow of current; see FIG. 10). At this time, a series circuit of the first recovery inductor LA and the panel capacity CXY between sustain electrode X and scan electrode Y receives the voltage Vs/2 from the first recovery capacitor CA to resonate. Therefore, the potential of the scan electrode Y declines smoothly. The second sustain pulse generating section 4B operates in the same manner as in mode V.

<Mode VII>

In the first sustain pulse generating section 2A, when the resonance current is attenuated substantially to zero, the first low side diode D2A is turned off. Further, the potential of the scan electrode Y reaches the ground potential (about 0). At this time, the bidirectional switch section Q7 is turned on (see FIG. 3A). As a result, the potential of the scan electrode Y is sustained at the ground potential. In FIG. 11A, the first low side recovery switch element Q4A is maintained off in the period of mode VII, but it may be on. The first low side recovery switch element Q4A may be turned off anytime by the end of mode I, and it may be turned off anytime from mode VII to mode XII or I. In the second sustain pulse generating section 4B, the operation is same as in mode VI.

<Mode VIII>

In the first sustain pulse generating section 2A, the bidirectional switch section Q7 is off, and the second low side recovery switch element Q4B is maintained on. As a result, the loop is formed, including ground terminal←second recovery capacitor CB←second low side diode D2B←second low side recovery switch element Q4B←second recovery inductor LB←output terminal 2C←panel capacity CXY between sustain electrode X and scan electrode Y←grounding switch 3B←ground terminal (the arrow indicates the flow of current; see FIG. 2, FIG. 3A). At this time, a series circuit of the second recovery inductor LB and the panel capacity CXY between sustain electrode X and scan electrode Y receives the voltage −Vs/2 from the second recovery capacitor CB to resonate. Therefore, the potential of the scan electrode Y declines smoothly. The second sustain pulse generating section 4B operates in the same manner as in mode VII.

<Mode IX>

In the first sustain pulse generating section 2A, when the resonance current generated in mode VIII is attenuated substantially to zero, the second low side diode D2B is turned off. Further, the potential of the scan electrode Y reaches the potential −Vs of the negative potential terminal 1N of the DC-DC converter 1 (that is, lower limit of sustain pulse voltage). At this time, the first low side sustain switch element Q2 is turned on (see FIG. 3A). As a result, the potential of the scan electrode Y is sustained at the lower limit −Vs of the sustain pulse voltage. In FIG. 1A, the second low side recovery switch element Q4B is maintained off in the period of mode IX, but it may be on. The second low side recovery switch element Q4B may be turned off anytime by the end of mode XI, and it may be turned off anytime between mode IX and mode XI.

In the discharge cell of the PDP 10 in which wall charge is accumulated in the address period, since the wall voltage is added to the lower limit −Vs of the sustain pulse voltage, the voltage between the scan electrode Y and the sustain electrode X exceeds the firing voltage. Therefore, the discharge continues to emit light. At this time, the electric power for sustaining the discharge current is supplied from the DC-DC converter 1 to the PDP 10 by way of the negative potential terminal 1N and the first low side sustain switch element Q2. The second sustain pulse generating section 4B operates in the same manner as in mode VIII.

<Mode X>

The first sustain pulse generating section 2A operates in the same manner as in mode IX. In the second sustain pulse generating section 4B, the second low side sustain switch element Q6 is off, and the third high side recovery switch element Q3C is maintained on (see FIG. 4). As a result, the loop is formed, including ground terminal←grounding switch 3B←panel capacity CXA between sustain electrode X and address electrode A←output terminal 4D of second sustain pulse generating section 4B←third recovery inductor LC←third high side recovery switch element Q3C←third high side diode D1C←third recovery capacitor CC←ground terminal (the arrow indicates the flow of current; see FIG. 10, FIG. 4). At this time, a series circuit of the third recovery inductor LC and the panel capacity CXA between sustain electrode X and address electrode A receives the voltage Ve/2 from the third recovery capacitor CC to resonate. Therefore, the potential of the address electrode A increases smoothly.

<Mode XI>

In the first sustain pulse generating section 2A, the operation is same as in mode X. In the second sustain pulse generating section 4B, when the resonance current is attenuated substantially to zero, the third high side diode D1C is turned off, and the potential of the address electrode A reaches the high potential voltage Ve. At this time, the second high side sustain switch element Q5 is turned on, and address electrode A is sustained at high potential Ve (see FIG. 4). Herein, the potential Ve of the address electrode A is close to the potential Vs of the scan electrode Y.

<Mode XII>

In the second sustain pulse generating section 2A, the first low side sustain switch element Q2 is off, and the second high side recovery switch element Q3B is maintained on. As a result, the loop is formed including ground terminal→second recovery capacitor CB→second high side diode D1B→second high side recovery switch element Q3B→second recovery inductor LB→output terminal 2C→panel capacity CXY between sustain electrode X and scan electrode Y→grounding switch 3B→ground terminal (the arrow indicates the flow of current; see FIG. 10, FIG. 3A).

At this time, a series circuit of the second recovery inductor LB and the panel capacity CXY between sustain electrode X and scan electrode Y receives the voltage −Vs/2 from the second recovery capacitor CB to resonate. Therefore, the potential of the scan electrode Y increases smoothly.

When the resonance current is attenuated substantially to zero, the second high side diode D1B is turned off, and the potential of the scan electrode Y reaches the ground potential (about 0). At this time, the bidirectional switch section Q7 is turned on, and the potential of the scan electrode Y is sustained at the ground potential, and the operation is same as in mode I (see FIG. 3A).

The driving method in the case of the power recovery section 6 as shown in FIG. 3B is explained by referring to FIG. 11B. FIG. 11B shows driving waveforms by the driving method of the embodiment in the case of power recovery section 6 as shown in FIG. 3B.

<Mode I>

In the first sustain pulse generating section 2A, the first high side sustain switch element Q1, the first low side sustain switch element Q2, and the fourth low side recover switch element Q4D are maintained in OFF state, while the fourth high side recovery switch element Q3D is maintained on. As a result, the conduction path is formed, including ground terminal→fourth high side diode D1D→fourth high side recovery switch element Q3D→fourth recovery inductor LD→output terminal 2C (the arrow indicates the flow of current; see FIG. 3B). Further, the conduction path is formed including output terminal 2C→panel capacity CXY between sustain electrode X and scan electrode Y→grounding switch 3B→ground terminal (the arrow indicates the flow of current; see FIG. 10). At this time, a series circuit of the fourth recovery inductor LD and the panel capacity CXY between sustain electrode X and scan electrode Y resonates. Therefore, the potential of the scan electrode Y increases smoothly.

In the second sustain pulse generating section 4B, the second high side sustain switch element Q5 is maintained in ON state, while the second low side sustain switch element Q6 and the third high side recovery switch element Q4C are maintained in OFF state (see FIG. 4). As a result, the address electrode A is sustained at high potential (about Ve). In FIG. 11B, the third high side recovery switch element Q3C is off, but it may be on. The third high side recovery switch element Q3C may be turned off anytime by the end of mode II, and it may be turned off anytime from mode VIII to mode I or II.

<Mode II>

In the first sustain pulse generating section 2A, when the resonance current is attenuated substantially to zero, the fourth high side diode D1D is turned off. Further, the potential of the scan electrode Y reaches the potential +Vs of the positive potential terminal 1P of the DC-DC converter 1 (that is, the upper limit of sustain pulse voltage). At this time, the first high side sustain switch element Q1 is maintained on (see FIG. 3B). As a result, the potential of the scan electrode Y is sustained at the upper limit +Vs of the sustain pulse voltage. In FIG. 11B, the fourth high side recovery switch element Q3D is off, but it may be on. The fourth high side recovery switch element Q3D may be turned off anytime by the end of mode IV, and it may be turned off anytime between mode II and mode IV.

In the second sustain pulse generating section 4B, the operation is same as in mode I.

In the discharge cell of the PDP 10 in which wall charge is accumulated in the address period, since the wall voltage is added to the upper limit +Vs of the sustain pulse voltage, the voltage between the scan electrode Y and the sustain electrode X exceeds the firing voltage. Therefore, the discharge continues to emit light. At this time, the electric power for sustaining the discharge current is supplied from the DC-DC converter 1 to the PDP 10 by way of the positive potential terminal 1P and the first high side sustain switch element Q1.

<Mode III>

In the first sustain pulse generating section 2A, the operation is same as in mode III, but the discharge has been terminated. In the second sustain pulse generating section 4B, the second high side sustain switch element Q5 is off, and the third low side recovery switch element Q4C is maintained on (see FIG. 4). As a result, the loop is formed, including ground terminal→grounding switch 3B→panel capacity CXA between sustain electrode X and address electrode A→output terminal 4D of second sustain pulse generating section 4B→third recovery inductor LC→third low side recovery switch element Q4C→third low side diode D2C→third recovery capacitor CC→ground terminal (the arrow indicates the flow of current; see FIG. 10, FIG. 4). At this time, a series circuit of the third recovery inductor LC and the panel capacity CXA between sustain electrode X and address electrode A receives the voltage Ve/2 from the third recovery capacitor CC to resonate. Therefore, the potential of the address electrode A declines smoothly.

<Mode IV>

In the first sustain pulse generating section 2A, the operation is same as in mode III. In the second sustain pulse generating section 4B, when the resonance current generated in mode III is attenuated substantially to zero, the third low side diode D2C is turned off. Further, the potential of the address electrode A reaches the potential of the low potential terminal 4N of the address power source 4H, that is, the ground potential. At this time, the second low side sustain switch element Q6 is turned on (see FIG. 4). As a result, the potential of the address electrode A is sustained at the ground potential. In FIG. 11B, the third low side recovery switch element Q4C is maintained off during the period of mode IV, but it may be on. The third low side recovery switch element Q4C may be turned off anytime by the end of mode VI, and it may be turned off anytime between mode IV and mode VI.

<Mode V>

After the potential of the scan electrode Y is sustained at the upper limit +Vs of the sustain pulse voltage for a predetermined time, in the first sustain pulse generating section 2A, the first high side sustain switch element Q1 is turned off, and the fourth low side recovery switch element Q4D is turned on. As a result, the conduction path is formed, including ground terminal←fourth low side diode D2D←fourth low side recovery switch element Q4D←fourth recovery inductor LD←output terminal 2C (the arrow indicates the flow of current; see FIG. 3B). Further, the conduction path is formed, including output terminal 2C←panel capacity CXY between sustain electrode X and scan electrode Y←grounding switch 3B←ground terminal (the arrow indicates the flow of current; see FIG. 10). At this time, a series circuit of the fourth recovery inductor LD and the panel capacity CXY between sustain electrode X and scan electrode Y resonates. Therefore, the potential of the scan electrode Y declines smoothly. In the second sustain pulse generating section 4B, the operation is same as in mode IV.

<Mode VI>

In the first sustain pulse generating section 2A, when the resonance current is attenuated substantially to zero, the fourth low side diode D2D is turned off. Further, the potential of the scan electrode Y reaches the potential −Vs of the negative potential terminal 1N of the DC-DC converter 1 (that is, lower limit of sustain pulse voltage). At this time, the first low side sustain switch element Q2 is turned on (see FIG. 3B). As a result, the potential of the scan electrode Y is sustained at the lower limit −Vs of the sustain pulse voltage. In FIG. 11B, the fourth low side recovery switch element Q4D is maintained off during the period of mode VI, but it may be on. The fourth low side recovery switch element Q4D may be turned off anytime by the end of mode VIII, and it may be turned off anytime between mode VI and mode VIII.

In the discharge cell of the PDP 10 in which wall charge is accumulated in the address period, since the wall voltage is added to the lower limit −Vs of the sustain pulse voltage, the voltage between scan electrode Y and sustain electrode X exceeds the firing voltage. Therefore, the discharge continues to emit light. At this time, the electric power for sustaining the discharge current is supplied from the DC-DC converter 1 to the PDP 10 by way of the negative potential terminal 1N and the first low side sustain switch element Q2. In the second sustain pulse generating section 4B, the operation is same as in mode VI.

<Mode VII>

In the first sustain pulse generating section 2A, the operation is same as in mode VI. In the second sustain pulse generating section 4B, the second low side sustain switch element Q6 is off, and the third high side recovery switch element Q3C is maintained on (see FIG. 4). As a result, the conduction path is formed, including ground terminal←grounding switch 3B←panel capacity CXA between sustain electrode X and address electrode A←output terminal 4D of second sustain pulse generating section 4B←third recovery inductor LC←third high side recovery switch element Q3C←third high side diode D1C←third recovery capacitor CC←ground terminal (the arrow indicates the flow of current; see FIG. 10, FIG. 4). At this time, a series circuit of the third recovery inductor LC and the panel capacity CXA between sustain electrode X and address electrode A receives the voltage Ve/2 from the third recovery capacitor CC to resonate. Therefore, the potential of the address electrode A increases smoothly.

<Mode VIII>

In the first sustain pulse generating section 2A, the operation is same as in mode VII. In the second sustain pulse generating section 4B, when the resonance current generated in mode VII is attenuated substantially to zero, the third high side diode D1C is turned off, and the potential of the address electrode A reaches the high potential voltage Ve. At this time, the second high side sustain switch element Q5 is turned on, and the address electrode A is sustained at the high potential Ve (see FIG. 4). Herein, the potential Ve of the address electrode A is close to the potential Vs of the scan electrode Y.

Afterwards, the operation of each switch element returns to mode I, which is continued during the sustain period.

As described herein, according to the PDP driving apparatus 30 in embodiment 3 of the invention, the sustain electrode driver 3 grounds the sustain electrode X during the sustain period, and thus the sustain electrode driver 3 does not have to include a sustain pulse generating section. Alternately, during the sustain period, contrary to the case above, the scan electrode driver 2 may ground the scan electrode Y, and the sustain electrode driver 3 may include the first sustain pulse generating section 2A. In such a case, the scan electrode driver 2 may not include a sustain pulse generating section. As a result, the sustain pulse generating section can be omitted in the scan electrode driver 2 or sustain electrode driver 3, and therefore the entire area of the driving apparatus is decreased, and flexibility of circuit design is enhanced. Hence, the PDP driving apparatus 30 in embodiment 3 of the invention may be easily reduced in size.

### Embodiment 4

In embodiment 3, while applying the pulse voltage of positive polarity to the address electrode A in the sustain period, the potential of the sustain electrode (or scan electrode) is fixed at a specific value. In this embodiment, during the reset period and the address period in addition to the sustain period, it is attempted to fix the potential of the sustain electrode (or scan electrode) at a specific value while applying pulse voltage of positive polarity to address electrode A.

The plasma display in embodiment 4 of the invention is similar to that in embodiment 2 (see FIG. 6) in structure. The structure can be explained by citing the explanation about embodiment 2 and FIG. 6.

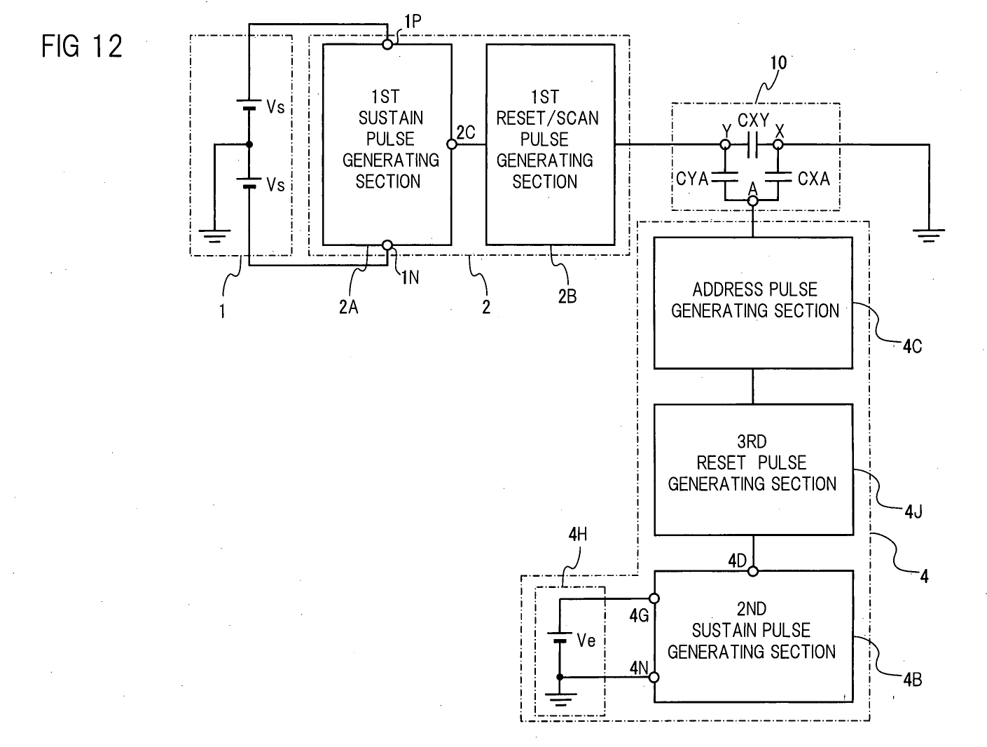

FIG. 12 is a block diagram of an equivalent circuit of the PDP 10 and the PDP driving apparatus 30 in embodiment 4 of the invention. In FIG. 6 and FIG. 12, similar elements are identified with same reference numerals.

In embodiment 4 of the invention, unlike embodiment 2, the grounding reference of the voltage applied to the second sustain pulse generating section 4B included in the address electrode driver 4 is different from that in embodiment 2. That is, the address power source 4H is a positive direct-current voltage source, and the high potential terminal 4G is set at a specific positive potential Ve, and the low potential terminal 4N is sustained at the ground potential. Since the scan electrode driver 2 is same as in embodiment 2, it can be explained by citing the description about embodiment 2 and FIG. 7.

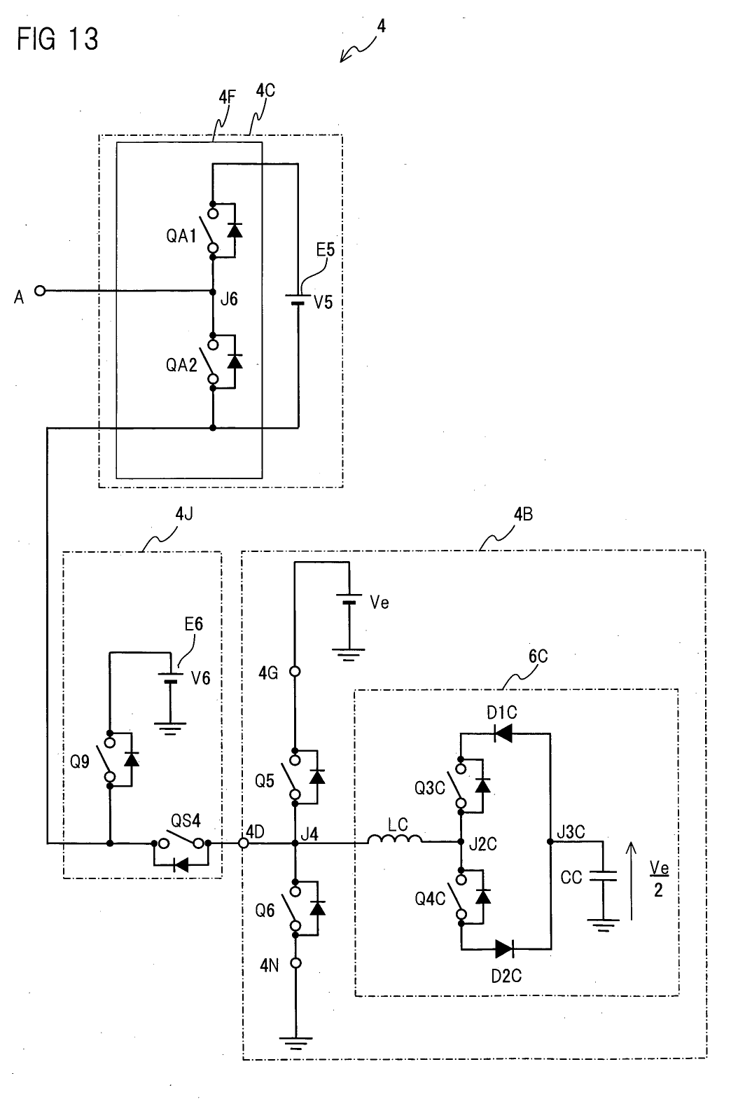

FIG. 13 is an equivalent circuit diagram of the address electrode driver 4. The address electrode driver 4 includes a second sustain pulse generating section 4B, an address pulse generating section 4C, and a second reset pulse generating section 4E. The structure of the second sustain pulse generating section 4B is the same as that in embodiment 3. The structure of the address pulse generating section 4C is the same as that in embodiment 2. Therefore, in FIG. 8 and FIG. 13, similar elements are identified with the same reference numerals. These similar elements can be explained by citing the descriptions in embodiments 2 and 3. The structure of the third power recovery circuit 6C is the same as that in embodiment 3.

A third reset pulse generating section 4J includes a sixth constant voltage source E6, a high side switch Q9, and a fourth separation switch element QS4. The constant voltage source E6 sustains the voltage between the positive electrode and the negative electrode at a specific value V6, for example, on the basis of the direct-current voltage applied from DC-DC converter 1.

Voltage V6 of the sixth constant voltage source E6 may be either higher or lower than output voltage Ve of the address power source 4H (see FIG. 12). In FIG. 13, voltage V6 of the sixth constant voltage source E6 is higher than the output voltage Ve of the address power source 4H: V6>Ve.

Address switch section 4F is actually provided as many as the number of plural address electrodes A1, A2, . . . (see FIG. 1), and connected to each one of the address electrodes A1, A2, . . . . Each address switch section 4F includes a series circuit of the high side address switch element QA1 and the low side address switch element QA2. The source of the high side address switch element QA1 is connected to the drain of low side address switch element QA2. Their junction point J6 is further connected to the corresponding address electrode A.

The positive electrode of the fifth constant voltage source E5 is connected to the drain of the high side address switch element QA1, and the negative electrode is connected to the source of the low side address switch element QA2. When voltage V6 of the sixth constant voltage source E6 is higher than the output voltage Ve of the address power source 4H (V6>Ve), as shown in FIG. 13, the drain of the fourth separation switch element QS4 is connected to the source of the high side address switch element QA2, and the source is connected to the output terminal 4D of the second sustain pulse generating section 4B. In the sustain period, the fourth separation switch element QS4 and the low side address switch element QA2 are on, shorting the path between the output terminal 4D of the second sustain pulse generating section 4B and the address electrode A (see explanation about embodiment 1).

The negative electrode of the sixth constant voltage source E6 is grounded, and the positive electrode thereof is connected to the drain of the high side switch element Q9. The source of the high side switch element Q9 is connected to the drain of the fourth separation switch element QS4.

When the voltage V6 of the sixth constant voltage source E6 is lower than the output voltage Ve of the address power source 4H (V6<Ve), unlike FIG. 13, the path between the source of the low side address switch element QA2 and the output terminal 4D of the second sustain pulse generating section 4B is shorted, forming a circuit having a diode inserted between the drain of the high side switch element Q9 and the sixth constant voltage source E6. The anode of the diode is connected to the sixth constant voltage source E6, and the cathode is connected to the drain of the high side switch element Q9 (not shown).

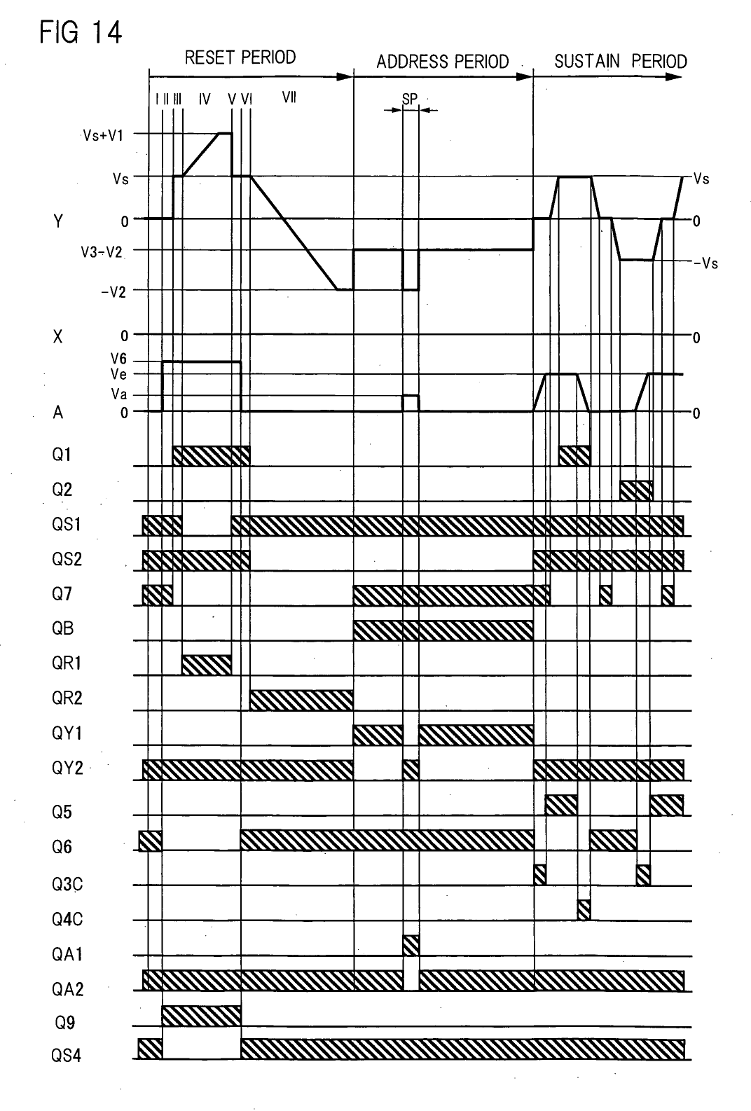

FIG. 14 is a waveform diagram showing potential changes in the scan electrode Y, the sustain electrode X and the address electrode A of the PDP 10 in the reset period, the address period, and the sustain period, respectively, in embodiment 4 of the invention. FIG. 14 further shows ON periods of switch elements Q1, Q2, QS1, QS2, Q7, QB, QR1, QR2, QY1, and QY2 included in the scan electrode driver 2, and ON periods of switch elements Q5, Q6, QS4, Q9, Q3C, Q4C, QA1, and QA2 included in the address electrode driver 4. In FIG. 14, the ON period of the switch element is indicated by shaded area.

When the voltage V6 of the sixth constant voltage source E6 is lower than the output voltage Ve of the address power source 4H (V6<Ve), the fourth separation switch element QS4 is not important because it is not shorted.

In the PDP driving apparatus 30 in embodiment 4 of the invention, unlike the conventional driving apparatus, the sustain electrode X is always sustained at the ground potential (about 0).

In the reset period, the potential of the scan electrode Y and the address electrode A varies by application of a reset pulse voltage. Depending on changes of the reset pulse voltage, the reset period is divided into seven modes I to VII as explained below.

<Mode I>

In the scan electrode driver 2, two separation switch elements QS1 and QS2, the bidirectional switch section Q7, and the low side scan switch element QY2 are maintained in ON state, while the remaining switch elements are maintained in OFF state (see FIG. 7). As a result, the scan electrode Y is sustained at the ground potential (about 0).

In the address electrode driver 4, the second low side sustain switch element Q6, the fourth separation switch element QS4, and the low side address switch element QA2 are maintained in ON state, while the remaining switch elements are maintained in OFF state (see FIG. 13). As a result, the address electrode A is sustained at the ground potential.

<Mode II>

In the scan electrode driver 2, the state in mode I is sustained. In the address electrode driver 4, the high side switch element Q9 is on, and the fourth separation switch element QS4 is maintained off. As a result, the address electrode A is sustained at potential V6 of the sixth constant voltage source E6.

<Mode III>

In the scan electrode driver 2, the first high side sustain switch element Q1 is on, and the bidirectional switch section Q7 is maintained off. At this time, two separation switch elements QS1 and QS2 and the low side scan switch element QY2 are maintained in ON state, while the remaining switch elements are maintained in OFF state. As a result, the potential of the scan electrode Y increases to the potential +Vs of the positive potential terminal 1P. In the address electrode driver 4, the state in mode II is sustained.

<Mode IV>

In the scan electrode driver 2, the first separation switch element QS1 is off, and the high side ramp waveform generator QR1 is maintained on. At this time, the first high side sustain switch element Q1, the second separation switch element QS2, and the low side scan switch element QY2 are maintained in ON state, while the remaining switch elements are maintained in OFF state. As a result, the potential of the scan electrode Y increases to the upper limit Vs+V1 of the reset pulse voltage from the potential +Vs of the positive potential terminal 1P at a specific speed.

In the address electrode driver 4, the state in mode III is maintained.

Thus, in all discharge cells of the PDP 10, uniformly, the application voltage increases relatively slowly to the upper limit Vs+V1 of the reset pulse voltage, accumulating uniform wall charge. At this time, since the elevation speed of the application voltage is small, light emission of the discharge cell is suppressed very small.

<Mode V>

In the scan electrode driver 2, the first separation switch element QS1 is on, and the high side ramp waveform generator QR1 is maintained off. At this time, the first high side sustain switch element Q1, the second separation switch element QS2, and low side scan switch element QY2 are maintained in ON state, while the remaining switch elements are maintained in OFF state. As a result, the potential of the scan electrode Y declines to the potential +Vs of the positive potential terminal 1P. In the address electrode driver 4, the state in mode IV is sustained. Thus, in all discharge cells of the PDP 10, the discharge stops to cause weak light emission to cease.

<Mode VI>

In the scan electrode driver 2, the state in mode V is sustained. Therefore, the potential of the scan electrode Y is sustained at the potential +Vs of the positive potential terminal 1P.

In the address electrode driver 4, the high side switch element Q9 is off, and the second low side sustain switch element Q6, and the fourth separation switch element QS4 are on. At this time, the low side address switch element QA2 is maintained in ON state, while the remaining switch elements are sustained on OFF state. As a result, the potential of the address electrode A declines to the ground potential.

<Mode VII>

In the scan electrode driver 2, the first high side sustain switch element Q1 and the second separation switch element QS2 are off, and low side ramp waveform generator QR2 is maintained on. At this time, the first separation switch element QS1 and the low side scan switch element QY2 are maintained in ON state, while the remaining switch elements are maintained in OFF state. As a result, the potential of the scan electrode Y declines from the potential +Vs of the positive potential terminal 1P to the lower limit −Vs of the reset pulse voltage at a specific speed. In the address electrode driver 4, the state in mode VI is sustained. Thus, the wall charge is uniformly removed and unified in all discharge cells of the PDP 10. At this time, application voltage increases or declines relatively slowly, and thus light emission of discharge cells can be suppressed very small.

During the address period, in the scan electrode driver 2, the low side ramp waveform generator QR2 is off, and the bypass switch element QB is maintained on. As a result, the source (or emitter) of the low side scan switch element QY2 is sustained at the lower limit −V2 of the scan pulse voltage. Further, for example, the bidirectional switch section Q7 is maintained on to sustain the first separation switch element QS1 in ON state.

In the address electrode driver 4, the low side sustain switch element Q6 and the fourth separation switch element QS4 are maintained in ON state. As a result, the source of the low side address switch element QA2 is sustained at the ground potential.

Upon start of the address period, the scan electrode driver 2 maintains the high side scan switch QY1 in ON state, and maintains the low side scan switch QY2 in OFF state, in all of scan electrodes Y1, Y2, Y3, . . . (see FIG. 1). As a result, the potential of all scan electrodes Y is uniformly sustained at the upper limit V3−V2 of the scan pulse voltage.

The scan electrode driver 2, successively, changes the potential of scan electrodes Y1, Y2, Y3, . . . , sequentially as follows (see scan pulse voltage SP shown in FIG. 14). When one electrode Y of the scan electrodes is selected, the high side scan switch element QY1 connected to the scan electrode Y is turned off, and the low side scan switch element QY2 is turned on. As a result, the potential of the scan electrode Y declines to the lower limit −V2 of the scan pulse voltage. This potential of the scan electrode Y is sustained at the lower limit −V2 of the scan pulse voltage for a specific time, then the low side scan switch element QY2 connected to this scan electrode Y is turned off, and the high side scan switch element QY1 is turned on. As a result, the potential of the scan electrode Y increases to the upper limit V3−V2 of the scan pulse voltage.

The scan electrode driver 2 similarly switches scan switch elements Q1Y and Q2Y connected to scan electrodes Y1, Y2, Y3, . . . , sequentially in the same manner described above. Thus, the scan pulse voltage SP is sequentially applied to the respective scan electrodes Y1, Y2, Y3, . . . .

Upon start of the address period, the address electrode driver 4 maintains the low side address switch element QA2 in ON state, and maintains the high side address switch element QA1 in OFF state, in all of address electrodes A1, A2, A3, . . . (see FIG. 1). Hence, the potential of all address electrodes A is sustained uniformly at the ground potential.

During the address period, the address electrode driver 4 selects one electrode A of the address electrodes on the basis of the video signal entered from outside, and increases the potential of the selected address electrode A to the upper limit Va of the address pulse voltage for a specific time.

For example, in the interval SP shown in FIG. 14, the scan pulse voltage is applied to one (Y) of the scan electrodes, and simultaneously, an address pulse voltage is applied to one (A) of the address electrodes. At this time, the voltage −V2+Va corresponding to difference between the lower limit −V2 of the scan pulse voltage and the upper limit Va of the address pulse voltage is applied between the scan electrode Y and the address electrode A. This voltage is higher than the voltage on the other combinations of scan electrode and address electrode. Therefore, in the discharge cell located at intersection of the scan electrode Y and the address electrode A selected at the same time in the interval SP, the discharge occurs between the scan electrode Y and the address electrode A. As a result, on the scan electrode Y at this discharge cell, in particular, a larger amount of wall charge is accumulated than at other discharge cells.

During the discharge period, the scan electrode driver 2 maintains the two separation switch elements QS1 and QS2, and the low side scan switch element QY2 in ON state. Thus, the path between the output terminal 2C of the first sustain pulse generating section 2A and the scan electrode Y is shorted. On the other hand, the address electrode driver 4 maintains the fourth separation switch element QS4 and the low side address switch element QA2 in ON state. As a result, the path between the output terminal 4D of the second sustain pulse generating section 4B and the address electrode A is shorted.

In this state, the first sustain pulse generating section 2A and the second sustain pulse generating section 4B operate in the same manner as in embodiment 3. As a result, the sustain pulse voltage is applied to the scan electrode Y and the address electrode A same as in embodiment 3 (see FIG. 1A). At this time, in the discharge cell in which a relatively large amount of wall charge is accumulated in the address period, the discharge continues to emit light.

As described herein, in the PDP driving apparatus 30 in embodiment 4 of the invention, the sustain electrode X is always sustained at the ground potential. That is, the sustain electrode driver 3 may serve as just a junction between the sustain electrode X and the ground terminal. Instead, the address electrode driver 4 includes the second sustain pulse generating section 4B and the third reset pulse generating section 4J, in addition to the address pulse generating section 4C. Hence, substantially, the sustain electrode driver 3 can be omitted, and thus the PDP driving apparatus can be reduced in size.

Moreover, generators of pulse voltages and power source are concentrated in layout on the scan electrode Y side of the PDP 10. That is, the noise source and heat source of the PDP driving apparatus 30 are gathered at the scan electrode Y side of the PDP 10. Therefore, measures against noise and heat are easy.

For example, other high frequency circuits relatively less resistant to noise, such as tuner, may be disposed on the sustain electrode X side of the PDP 10. At this time, adverse effects by noise from the PDP driving apparatus 30 can be effectively avoided.

Further, the cooling range by fans or other cooling devices may be limited to the scan electrode Y side of the PDP 10. As a result, the cooling efficiency may be enhanced effectively.

In FIG. 14, the voltage waveform in sustain period is shown as waveform assuming the recovery circuit unit shown in FIG. 3A. However it may also assumed on the basis of recovery circuit section shown in FIG. 3B, and in such a case, the voltage waveform during the sustain period and on/off state of switch elements are as shown in FIG. 11B.

The invention is described herein in relation to specific embodiments, but the invention may be changed and modified in several forms, easily by those skilled in the art, without departing from the spirit of the essential characteristics thereof. Hence the invention is not limited to the present embodiments alone, but is defined by the appended claims thereof. This application is related to Japanese Patent Application No. 2004-164593, filed Jun. 2, 2004, the contents of which are incorporated herein by reference.

### INDUSTRIAL APPLICABILITY

The invention is useful for a driving apparatus of a plasma display panel, and a display device provided with the plasma display.

1. A plasma display panel (PDP) driving apparatus for driving a plasma display panel having address electrodes, sustain electrodes and scan electrodes, comprising:
a sustain pulse generator operable to sustain one of the sustain electrode and the scan electrode at a predetermined voltage, and apply alternately a first positive pulse voltage and a first negative pulse voltage to the other, as a sustain pulse voltage, during a sustain period; and
an address voltage generator operable to apply a voltage which changes temporally to the address electrode, during the sustain period.

2. The PDP driving apparatus according to claim 1, wherein the address voltage generator applies a second pulse voltage with a specific polarity to the address electrode, in synchronization with the pulse with the same polarity as the second pulse voltage out of the sustain pulse voltages, during the sustain period.

3. The PDP driving apparatus according to claim 2, wherein a maximum amplitude of the second pulse voltage is smaller than a maximum amplitude of the pulse with the same polarity as the second pulse voltage out of the sustain pulse voltages.

4. The PDP driving apparatus according to claim 2, wherein the second pulse voltage has a negative polarity.

5. The PDP driving apparatus according to claim 2, further comprising:
a reset pulse generator operable to sustain the sustain electrode at a ground potential and apply a reset pulse voltage to the scan electrode, during a reset period; and
a scan pulse generator operable to sustain the sustain electrodes at a ground potential and apply a scan pulse voltage to the scan electrode, during an address period,
wherein the sustain pulse generator sustains the sustain electrodes at a ground potential during the sustain period.

6. The PDP driving apparatus according to claim 1, wherein the address voltage generator changes a potential of the address electrode from a ground potential to a negative predetermined potential while the sustain pulse voltage changes from a maximum value to a minimum value, and changes the potential of the address electrode from a negative predetermined potential to a ground potential while the sustain pulse voltage changes from the minimum value to the maximum value, during the sustain period.

7. The PDP driving apparatus according to claim 6, further comprising:
a reset pulse generator operable to sustain the sustain electrodes at a ground potential and apply a reset pulse voltage to the scan electrode, during the reset period, and
a scan pulse generator operable to sustain the sustain electrodes at a ground potential and apply a scan pulse voltage to the scan electrode, during the address period,
wherein the sustain pulse generator sustains the sustain electrode at a ground potential during the sustain period.

8. The PDP driving apparatus according to claim 1, wherein the address voltage generator controls a potential of the address electrode at least in two different potentials during the sustain period, lowers the potential of the address electrode during application of the first positive pulse voltage, and raises the potential of the address electrode during application of the first negative pulse voltage.

9. The PDP driving apparatus according to claim 8, wherein a lowest one of the controlled potentials of the address electrode is a ground potential.

10. The PDP driving apparatus according to claim 8, further comprising:
a reset pulse generator operable to sustain the sustain electrodes at a ground potential and apply a reset pulse voltage to the scan electrode, during the reset period, and
a scan pulse generator operable to sustain the sustain electrodes at a ground potential and apply a scan pulse voltage to the scan electrode, during the address period,
wherein the sustain pulse generator sustains the sustain electrodes at a ground potential during the sustain period.

11. The PDP driving apparatus according to claim 1, wherein the address voltage generator lowers a potential of the address electrode while the sustain pulse voltage changes from a maximum value to a minimum value, and raises the potential of the address electrode while the sustain pulse voltage changes from the minimum value to the maximum value, during the sustain period.

12. The PDP driving apparatus according to claim 11, further comprising:
a reset pulse generator operable to sustain the sustain electrodes at a ground potential and apply a reset pulse voltage to the scan electrode, during the reset period, and
a scan pulse generator operable to sustain the sustain electrodes at a ground potential and apply a scan pulse voltage to the scan electrode, during the address period,
wherein the sustain pulse generator sustains the sustain electrodes at a ground potential during the sustain period.

13. A plasma display, comprising:
a plasma display panel including discharge cells that emits light by discharge of a gas packed inside, and sustain electrodes, scan electrodes and address electrodes that apply a predetermined voltage to the discharge cells; and
a PDP driving apparatus according to claim 1 for driving the plasma display panel.
